(19) United States
(12) Patent Application Publication
(10) Pub. No.: US 2024/0175144 A1
(43) Pub. Date: May 30, 2024

(54) AMMONIA-ASSISTED CO2 CAPTURING AND UPGRADING TO VALUABLE CHEMICALS

(71) Applicant: IOWA STATE UNIVERSITY RESEARCH FOUNDATION, INC., Ames, IA (US)

(72) Inventors: Wenzhen LI, Ames, IA (US); Jungkuk LEE, Ames, IA (US); Hengzhou LIU, Ames, IA (US); Yifu CHEN, Ames, IA (US)

(21) Appl. No.: 18/485,114

(22) Filed: Oct. 11, 2023

Related U.S. Application Data
(60) Provisional application No. 63/415,154, filed on Oct. 11, 2022.

(51) Int. Cl. C25B 3/07; C25B 3/26; C25B 11/031; C25B 11/065; C25B 11/089

(52) U.S. Cl. CPC C25B 3/07; C25B 3/26; C25B 11/031; C25B 11/065; C25B 11/089

(57) ABSTRACT

The present disclosure relates to an electrochemical method for converting captured CO₂ into formate (HCOO₋). This method involves capturing waste CO₂ by co-absorption of the waste CO₂ with green ammonia (NH₃) to form ammonium bicarbonate (NH₄HCO₃) and converting the ammonium bicarbonate (NH₄HCO₃) into formate (HCOO⁻), wherein said converting is carried out in an integrated flow electrolyzer system. Another aspect of the present disclosure relates to an integrated flow electrolyzer system comprising an alkaline electrolyzer for producing green NH₃ from NO₃⁻, an NH₃—CO₂ absorbing unit whereby waste CO₂ is co-absorbed with ammonia (NH₃) to form ammonium bicarbonate (NH₄HCO₃), and a bicarbonate electrolyzer for converting the ammonium bicarbonate (NH₄HCO₃) into formate (HCOO⁻).

This application claims the benefit of U.S. Provisional Patent Application Ser. No. 63/415,154, filed Oct. 11, 2022, which is hereby incorporated by reference in its entirety.

This invention was made with government support under grant number 2021-67021-34650 awarded by USDA/NIFA and grant number CHE2036944 awarded by National Science Foundation. The government has certain rights in the invention.

### FIELD OF THE INVENTION

Disclosed herein are methods for ammonia-assisted capturing and upgrading of CO₂ to valuable chemicals and electrolyzers for carrying out such methods.

### BACKGROUND OF THE INVENTION

Reduction of the net CO₂ emissions to zero by 2025 is an urgent need for limiting the global warming to a safe level (Nitopi et al., “Progress and Perspectives of Electrochemical CO₂ Reduction on Copper in Aqueous Electrolyte,” Chem. Rev. 119(12): 7610-7672 (2019); Pachauri et al., “Climate Change 2014: Synthesis Report. Contribution of Working Groups I, II and III to the Fifth Assessment Report of the Intergovernmental Panel on Climate Change,” Ipcc: (2014); Sullivan et al., “Coupling Electrochemical CO₂ Conversion with CO₂ Capture,” Nat. Catal. 4(11):952-958 (2021); Rogelj et al., “A New Scenario Logic for the Paris Agreement Long-term Temperature Goal,” Nature 573(7774):357-363 (2019)). Powered by renewable electricity from solar or wind sources, CO₂ can be electrochemically converted into valuable chemicals and fuels (i.e., the CO₂ reduction reaction, or CO₂RR) (Nitopi et al., “Progress and Perspectives of Electrochemical CO₂ Reduction on Copper in Aqueous Electrolyte,” Chem. Rev. 119(12): 7610-7672 (2019); De Luna et al., “What Would it Take for Renewably Powered Electrosynthesis to Displace Petrochemical Processes?,” Science 364(6438): eaav3506 (2019)). However, CO₂ electrolyzers in most studies are fed with pressurized and purified CO₂ gas, production of which requires energy- and capital-intensive regeneration processes from the captured CO₂ (Keith et al., “A Process for Capturing CO₂ From the Atmosphere.” Joule 2(8): 1573-1594 (2018); Welch et al., “Bicarbonate or Carbonate Processes for Coupling Carbon Dioxide Capture and Electrochemical Conversion,” ACS Energy Lett. 5(3):940-945 (2020)). Specifically, after capturing CO₂ from air or flue gases, the release of CO₂ is usually accomplished by heating the capturing media at 120-150° C. (Boot-Handford et al., “Carbon Capture and Storage Update,” Energy Environ. Sci 7(1): 130-189 (2014); Haszeldine, R. S., “Carbon Capture and Storage: How Green Can Black Be?,” Science 325(5948): 1647-1652 (2009)). Then, the collected CO₂ must be compressed into a pressurized container for storage and transportation before its utilization. Therefore, integrating CO₂ capture and conversion steps is vital to decreasing the energy costs and making the overall process sustainable (Welch et al., “Bicarbonate or Carbonate Processes for Coupling Carbon Dioxide Capture and Electrochemical Conversion,” ACS Energy Lett. 5(3):940-945 (2020); Pérez-Gallent et al., “Integrating CO₂ Capture with Electrochemical Conversion Using Amine-Based Capture Solvents as Electrolytes,” Ind. Eng. Chem. Res. 60(11):4269-4278 (2021)).

KOH(aq)+CO₂(g)→KHCO₃(aq) (RXN 1)

2RNH₂(aq)+CO₂(g)→RNHCOO⁻(aq)+RNH₃ (aq) (RXN 2)

CO₂(g)+H₂O(l)+NH₃(g)→NH₄HCO₃(aq) (RXN 3)

One strategy is to convert CO₂ directly in its capture solutions upon its in situ release (Welch et al., “Bicarbonate or Carbonate Processes for Coupling Carbon Dioxide Capture and Electrochemical Conversion,” ACS Energy Lett. 5(3):940-945 (2020)). In bipolar membrane (“BPM”)-based electrolyzers, aqueous bicarbonate—generated by absorbing CO₂ in KOH capture solution (RXN 1)—can react with H⁺ produced by the BPM to form in situ CO₂ (“i-CO₂”) at the BPM-electrode interface (RXN 4), which can be subsequently converted into value-added products such as CO (Lees et al., “Electrodes Designed for Converting Bicarbonate Into CO,” ACS Energy Lett. 5(7):2165-2173 (2020); Zhang et al., “Porous Metal Electrodes Enable Efficient Electrolysis of Carbon Capture Solutions,” Energy Environ. Sci. 15:705-713 (2022); Lees et al., “Continuum Model to Define the Chemistry and Mass Transfer in a Bicarbonate Electrolyzer,” ACS Energy Lett. 7:834-842 (2022); Yang et al., “Cation-Driven Increases of CO₂ Utilization in a Bipolar Membrane Electrode Assembly for CO₂ Electrolysis,” ACS Energy Lett. 6(12):4291-4298 (2021); Blommaert et al., “Insights and Challenges for Applying Bipolar Membranes in Advanced Electrochemical Energy Systems,” ACS Energy Lett. 6(7):2539-2548 (2021)), formate (Li et al., “Conversion of Bicarbonate to Formate in an Electrochemical Flow Reactor,” ACS Energy Lett. 5(8):2624-2630 (2020)), and CH₄ (Lees et al., “Electrolytic Methane Production from Reactive Carbon Solutions,” ACS Energy Lett. 7:1712-1718 (2022)). However, the performance of such bicarbonate electrolyzers is inferior to direct CO₂ electrolyzers fed with gaseous CO₂, largely due to the inadequate local i-CO₂ concentration (Kas et al., “Modeling the Local Environment within Porous Electrode during Electrochemical Reduction of Bicarbonate,” Ind. Eng. Chem. Res., 61(29): 10461-10473 (2022); Kim et al., “Electrocatalytic Reduction of Low Concentrations of CO₂ Gas in a Membrane Electrode Assembly Electrolyzer,” ACS Energy Lett. 6(10):3488-3495 (2021)). Besides, the metal cation bicarbonate electrolyzer has significantly higher electrical energy consumption because the BPM requires an additional potential of 0.828 V (under standard conditions) for H⁺ generation by water dissociation upon large current densities (Blommaert et al., “Insights and Challenges for Applying Bipolar Membranes in Advanced Electrochemical Energy Systems,” ACS Energy Lett. 6(7): 2539-2548 (2021)), and BPM is thicker than conventional cation exchange membranes (“CEM”) and anion exchange membranes (“AEM”).

Apart from the KOH solution, amines such as monoethanolamine (“MEA”) solution are commonly used for capturing CO₂ due to the facile kinetics of the formation of amine-CO₂ adducts (RXN 2) (Lee et al., “Electrochemical Upgrade of CO₂ From Amine Capture Solution,” Nat. Energy 6(1):46-53 (2021); Chen et al., “Electrochemical Reduction of Carbon Dioxide in a Monoethanolamine Capture Medium,” (hemSusChem 10(20):4109-4118 (2017); Rochelle, G. T., “Amine Scrubbing for CO₂ Capture,” Science 325(5948): 1652-1654 (2009)). Conversion of MEA-CO₂ adduct to CO in the BPM-based electrolyzers has been reported in previous studies but only at low current densities (<50 mA cm⁻²) (Lee et al., “Electrochemical Upgrade of CO₂ From Amine Capture Solution,” Nat. Energy 6(1):46-53 (2021); Chen et al., “Electrochemical Reduction of Carbon Dioxide in a Monoethanolamine Capture Medium,” ChemSusChem 10(20):4109-4118 (2017); Kim et al., “Insensitive Cation Effect on Single-atom Ni Catalyst Allows Selective Electrochemical Conversion of Captured CO₂ in Universal Media,” Energy & Environmental Science 15(10):DOI:10.1039/D2EE01825J (2022)). In addition to the insufficient i-CO₂ concentration, the bulky carbamate (RNHCOO⁻) and ethanolammonium (RNH₃⁺) ions may hinder the mass transport at the electrode double layer, which limits the i-CO₂RR performance.

As a suitable alternative, CO₂ can be captured by ammonia (NH₃) solution to form ammonium bicarbonate (NH₄HCO₃) (RXN 3) (Kim et al., “Insensitive Cation Effect on Single-atom Ni Catalyst Allows Selective Electrochemical Conversion of Captured CO₂ in Universal Media,” Energy & Environmental Science 15(10):DOI:10.1039/D2EE01825J (2022); Zhao et al., “Post-combustion CO₂ Capture by Aqueous Ammonia: A State-of-the-art Review,” Int. J. Greenh. Gas Control. 9:355-371 (2012)). Compared to MEA, NH₃ has higher CO₂-capturing capacity because it doubles the stoichiometric ratio of CO₂ to the capturing agent (see RXN 2 and 3) (Shakerian et al., “A Comparative Review Between Amines and Ammonia as Sorptive Media for Post-combustion CO₂ Capture,” Appl. Energy 148:10-22 (2015)). More importantly, release of CO₂ from NH₄HCO₃ requires much lower energy than that from MEA-CO₂ or KHCO₃, as illustrated by their decomposition temperatures: 36° C., 120° C., and 150° C. for NH₄HCO₃, MEA-CO₂, and KHCO₃, respectively (Wang et al., “Current Status and Challenges of the Ammonia Escape Inhibition Technologies in Ammonia-based CO₂ Capture Process,” Appl. Energy 230:734-749 (2018)). The ease of CO₂ release from NH₄HCO₃ (RXN 5) is expected to provide sufficient i-CO₂ in the electrolyzer and facilitate i-CO₂RR with reduced energy input. Besides, the cost of NH₃ (13.5 USD per kmol) is much lower than that of KOH (86 USD per kmol) or MEA (92 USD per kmol), and NH₃ as the CO₂ capture agent is less corrosive and less toxic as compared to KOH (Wang et al., “Current Status and Challenges of the Ammonia Escape Inhibition Technologies in Ammonia-based CO₂ Capture Process,” Appl. Energy 230:734-749 (2018)). Moreover, NH₃ can be readily produced by the electro-reduction of NOₓ or NOₓ⁻ that are abundant in agricultural or industrial wastes (Liu et al., “Electrocatalytic Nitrate Reduction on Oxide-derived Silver with Tunable Selectivity to Nitrite and Ammonia,” ACS Catal. 11(14):8431-8442 (2021); Daiyan et al., “Nitrate Reduction to Ammonium: From CuO Defect Engineering to Waste NOₓ-to-NH₃ Economic Feasibility,” Energy Environ. Sci. 14(6):3588-3598 (2021); Kwon et al., “Nitric Oxide Utilization for Ammonia Production Using Solid Electrolysis Cell at Atmospheric Pressure,” ACS Energy Lett. 6(12):4165-4172 (2021); Kim et al., “Unveiling Electrode-Electrolyte Design-Based NO Reduction for NH₃ Synthesis,” ACS Energy Lett. 5(11):3647-3656 (2020)). Using waste-derived NH₃ for CO₂ capture and conversion will simultaneously alleviate the environmental burdens of NOₓ/NOₓ⁻ and CO₂ by “fixing” them into stable and value-added chemical products (FIG. 1) (van Langevelde et al., “Electrocatalytic Nitrate Reduction for Sustainable Ammonia Production,” Joule 5(2):290-294 (2021); Wang et al., “Nitrate Electroreduction: Mechanism Insight, In situ Characterization, Performance Evaluation, and Challenges,” Chem. Soc. Rev. 50(12):6720-6733 (2021)).

Conventional work: water dissociation driven in BPM electrolyzer

HCO₃⁻(aq)+H⁺(aq)→H₂O(l)+i-CO₂(g) (RXN 4)

One known obstacle to using NH₃ as the capture agent is its volatility, and it may escape from NH₃ solution during capturing operation and handling (Wang et al., “Current Status and Challenges of the Ammonia Escape Inhibition Technologies in Ammonia-based CO₂ Capture Process,” Appl. Energy 230:734-749 (2018)). Through a series of system modeling and optimization, such as the advanced flash stripper process (Jiang et al., “Advancement of Ammonia Based Post-combustion CO₂ Capture Using the Advanced Flash Stripper Process,” Appl. Energy 202:496-506 (2017); Jiang et al., “Advancement of Ammonia-based Post-combustion CO₂ Capture Technology: Process Modifications,” Fuel Processing Technology 210:106544 (2020)), both operational and economic feasibility have been demonstrated for NH₃-based CO₂ capture (chilled NH₃ process) (Hanak et al., “Efficiency Improvements for the Coal-fired Power Plant Retrofit With CO₂ Capture Plant Using Chilled Ammonia Process,” Appl. Energy 151:258-272 (2015); Li et al., “Technoeconomic Assessment of an Advanced Aqueous Ammonia-based Postcombustion Capture Process Integrated With a 650-MW Coal-fired Power Station,” Environ. Sci. Technol. 50(19): 10746-10755 (2016)) from post-combustion streams. For example, a proposed two-stage adsorption process has reduced NH₃ slip by more than 50%, leading to the recovery of >99% of vaporized NH₃ (Li et al., “Technical and Energy Performance of an Advanced, Aqueous Ammonia-based CO₂ Capture Technology for a 500 MW Coal-fired Power Station,” Environ. Sci. Technol. 49(16): 10243-10252 (2015)). The CO₂-avoided cost has been reduced to US$ 40.7/ton CO₂ for NH₃-based CO₂ capture, which is 44% less than the MEA-based process (US$ 75.1/ton CO₂) (Jiang et al., “Advancement of Ammonia Based Post-combustion CO₂ Capture Using the Advanced Flash Stripper Process,” Appl. Energy 202:496-506 (2017)). Although modeling has shown the success of the capability of using NH₃ as the capture agent, the utilization of CO₂ captured media—the direct conversion of NH₄HCO₃ solution in the electrolyzers—has never been developed. Besides, the previous studies were limited to theoretically modeling the technical and economic capability of NH₃-based CO₂ capture. Experimentally developing a combined process for NH₃-mediated CO₂ capture (with NH₃ derived waste resources) and its direct utilization (conversion in electrolyzers) is still lacking.

The present disclosure is directed to overcoming limitations in the art.

### SUMMARY OF THE INVENTION

One aspect of the present disclosure relates to an electrochemical method for converting captured CO₂ into formate (HCOO⁻). This method involves capturing waste CO₂ by co-absorption of the waste CO₂ with green ammonia (NH₃) to form ammonium bicarbonate (NH₄HCO₃) and converting the ammonium bicarbonate (NH₄HCO₃) into formate (HCOO⁻), wherein said converting is carried out in an integrated flow electrolyzer system.

Another aspect of the present disclosure relates to an integrated flow electrolyzer system comprising an alkaline electrolyzer for producing green NH₃ from NO₃⁻, an NH₃—CO₂ absorbing unit whereby waste CO₂ is co-absorbed with ammonia (NH₃) to form ammonium bicarbonate (NH₄HCO₃), and a bicarbonate electrolyzer for converting the ammonium bicarbonate (NH₄HCO₃) into formate (HCOO⁻).

The present disclosure involves an electrochemical process and integrated flow system for converting captured CO₂ into formate (HCOO⁻), as illustrated in FIG. 1 and FIG. 2, involving thermal decomposition driven in an AEM/CEM electrolyzer, according to the following reaction:

NH₄HCO₃(aq)→NH₄⁺(aq)+i-CO₂(g)+OH⁻(aq)

i-CO₂(g)+H₂O+2e⁻→HCOO⁻+HO⁻ (RXN 5).

Direct electrochemical conversion of CO₂ capture solutions (instead of gaseous CO₂) into valuable chemicals can circumvent the energy-intensive CO₂ regeneration and pressurization steps, but the performance of such processes is limited by the sluggish release of CO₂ and the use of energy-consuming bipolar membranes (BPMs). It has been unexpectedly discovered that an ammonium bicarbonate (NH₄HCO₃)-fed electrolyzer outperforms the state-of-the-art KHCO₃ electrolyzer owing to its favorable thermal decomposition property, which allows for a 3-fold increase of the in-situ CO₂ concentration, a 23% increase in formate faradaic efficiency, and a 35% reduction in cell voltage by substituting BPM with an anion exchange membrane. An integrated process of combining NH₄HCO₃ electrolysis with CO₂ capturing by on-site generated ammonia from the electro-reduction of nitrate is demonstrated, which features a remarkable 99.8% utilization of CO₂ capturing agent. Such a multi-purpose process offers a sustainable route for the simultaneous removal of N wastes and streamlined CO₂ capturing-upgrading.

### BRIEF DESCRIPTION OF THE DRAWINGS

FIG. 1 shows a schematic illustration of one embodiment of an integrated process of CO₂ capture and utilization disclosed herein. This process combines green NH₃ production from NO₃⁻, waste CO₂ capture by co-absorption with NH₃, and production of value-added commodity chemicals from the bicarbonate electrolyzers. In the NO₃ electrolyzer, the air was used as the carrier gas to purge NH₃-containing gases out of the reactor for its further capture of CO₂ in water: acid-base reaction between NH₃ and CO₂ (NH₃+CO₂+H₂O→NH₄HCO₃).

FIG. 2 shows a schematic illustration of one embodiment of an integrated process of CO₂ capture and utilization disclosed herein. This process combines green NH₃ production from NO₃⁻, waste CO₂ capture by co-absorption with NH₃, and production of value-added commodity chemicals from the bicarbonate electrolyzers.

FIG. 3 is a photograph showing an experimental system for the 5-hour electrolysis of NH₄HCO₃ in an AEM-based electrolyzer.

FIGS. 4A-C show the characterization of ED-Bi. FIG. 4A is an SEM image (scale bar=50 μm), FIG. 4B is an SEM image with higher magnification (scale bar=20 μm), and FIG. 4C shows the XRD pattern of ED-Bi.

FIGS. 5A-C show electrochemical conversion of CO₂ capture solutions to formate. FIG. 5A is a graph showing Faradaic efficiency (left Y-axis) of products and the amount of in situ generated CO₂ (right Y-axis) during the electrolysis of different CO₂ capture solutions (2.5 M for all cases): KHCO₃, NH₄HCO₃, and MEA-CO₂. The electrolysis was performed at 40° C.for 30 min at a constant current density of 100 mA cm⁻². The MEA-CO₂ adduct was prepared by bubbling CO₂ for 30 min into the solution of MEA, then purging argon to remove dissolved CO₂. 2.5 M KCl was added to the MEA-CO₂ solution to increase its conductivity (Lee et al., “Electrochemical Upgrade of CO₂ From Amine Capture Solution,” Nat. Energy 6(1):46-53 (2021), which is hereby incorporated by reference in its entirety). FIGS. 5B-C are graphs providing a comparison of formate faradaic efficiency with KHCO₃ and NH₄HCO₃ at different current densities (FIG. 5B) and different cell temperatures (FIG. 5C) during 30-min electrolysis. The catholyte volume was 40 mL for 100-150 mA cm⁻² and 120 mL for 200-300 mA cm⁻².

FIGS. 6A-B are graphs showing a comparison of H₂ faradaic efficiency between KHCO₃ and NH₄HCO₃ at different current densities (FIG. 6A) and different cell temperatures (FIG. 6B) for BPM-based electrolysis for half-hour operation. The catholyte volume was 120 mL for 200-300 mA cm⁻² and 40 mL for 100-150 mA cm⁻².

FIGS. 7A-F show conversion of NH₄HCO₃ in the electrolyzers with different membranes. FIG. 7A is a graph showing the cell voltage profile, and FIG. 7B is a graph showing faradaic efficiency (left Y-axis) of products and the amount of in situ generated CO₂ (right Y-axis) for the electrolysis of KHCO₃ and NH₄HCO₃ with different membranes: BPM, CEM, and AEM. The electrolysis was performed at 40° C.for 30 min at a constant current density of 100 mA cm⁻². FIG. 7C provides a graphical comparison of the cell voltage and the FE towards product (formate) in this work with the reported performances (Lees et al., “Electrodes Designed for Converting Bicarbonate Into CO,” ACS Energy Lett. 5(7):2165-2173 (2020); Zhang et al., “Porous Metal Electrodes Enable Efficient Electrolysis of Carbon Capture Solutions,” Energy Environ. Sci. 15:705-713 (2022); Li et al., “Conversion of Bicarbonate to Formate in an Electrochemical Flow Reactor,” ACS Energy Lett. 5(8):2624-2630 (2020); Li et al., “CO₂ Electroreduction From Carbonate Electrolyte,” ACS Energy Lett. 4(6): 1427-1431 (2019); which are hereby incorporated by reference in their entirety) using KHCO₃ and BPM at 100 mA cm⁻². FIG. 7D is a schematic illustration of the local environment at the cathode for the electrolyzers with NH₄HCO₃ feed when using different membranes. FIG. 7E is a graph showing cell voltage—time profile and formate faradaic efficiency (both catholyte and anolyte) for 5-hour electrolysis in AEM-based system at 40° C. FIG. 7F is a graph showing the amount of NH₄⁺ monitored in the NH₄HCO₃ solution and the NH₃-absorbing solution during 5-hour electrolysis.

FIG. 8 is an SEM image of ED-Bi after electrolysis.

FIG. 9 is a graph showing an analysis of the energy consumption for formic acid production from CO₂ electro-reduction with different cell configurations. Case 1-i and 1-ii correspond to the electrolyzers with gaseous CO₂ feed, and case 2-i to 2-v correspond to the electrolyzers fed with CO₂ capture solutions.

FIG. 10 is a photograph showing an experimental system for the production of NH₄HCO₃ from CO₂ and NO₃⁻-derived NH₃.

FIG. 11 is a graph showing the cell voltage profile of NH₃ production by NO₃⁻ reduction in the alkaline electrolyzer for 6-hour electrolysis.

FIGS. 12A-C show an integrated process combining CO₂ capturing by NO₃⁻ derived NH₃ and formate production from NH₄HCO₃. FIG. 12A is a graph showing utilization of the reaction ingredients for each individual process, including 1) electron utilization (faradaic efficiency) of the electrochemical NO₃⁻-to-NH₃ reaction; 2) utilization of the on-site generated CO₂ capturing agent (NH₃) for NH₄⁻HCO₃ production; 3) electron utilization (faradaic efficiency) of the electrochemical formate production from the as-prepared NH₄HCO₃. The NH₄HCO₃ solution for electrolysis was prepared by dissolving 7.9 g of the NH₄HCO₃ (obtained by the reaction between NO₃-derived NH₃ and CO₂) in 40 mL of deionized water. FIGS. 12B-C provide a graphical comparison of XRD patterns (FIG. 12B), and ¹H NMR spectrum (FIG. 12C) of the as-prepared NH₄HCO₃ and the commercial product.

### DETAILED DESCRIPTION OF THE INVENTION

The present disclosure relates to electrolysis methods and systems for converting captured CO₂ into formate (HCOO⁻). Electrolysis is a process where electrical current is used to drive a non-spontaneous redox reaction.

One aspect of the present disclosure relates to an electrochemical method for converting captured CO₂ into formate (HCOO⁻). This method involves capturing waste CO₂ by co-absorption of the waste CO₂ with ammonia (NH₃) to form ammonium bicarbonate (NH₄HCO₃) and converting the ammonium bicarbonate (NH₄HCO₃) into formate (HCOO⁻), wherein said converting is carried out in an integrated flow electrolyzer system.

Another aspect of the present disclosure relates to an integrated flow electrolyzer system comprising an alkaline electrolyzer for producing NH₃ from NO₃, an NH₃—CO₂ absorbing unit whereby waste CO₂ is co-absorbed with ammonia (NH₃) to form ammonium bicarbonate (NH₄HCO₃), and a bicarbonate electrolyzer for converting the ammonium bicarbonate (NH₄HCO₃) into formate (HCOO⁻).

In some embodiments, the ammonia (NH₃) co-absorbed with waste CO₂ in the methods and systems of the present disclosure is green ammonia (NH₃). As used herein, “green” ammonia (NH₃) is NH₃ produced from waste reactive nitrogen, or from reduction of N₂ by green H₂. In some embodiments, the NH₃ can be readily produced by the electro-reduction of NOₓ or NOₓ⁻ that are abundant in agricultural or industrial wastes.

In the electrochemical methods and systems disclosed herein, the capture of waste CO₂ by co-absorption may be carried out, for example and without limitation, through an integrated electricity-driven process for economically upcycling waste nitrogen enabled by low-concentration NO₃⁻ electrodialysis and high-performance NH₃ electrosynthesis from various reactive nitrogen (Nr) forms. For example, an integrated electricity-driven process may comprise the following three core components: (i) NO₃⁻ recovery from low-concentration waste streams by electrodialysis, (ii) Nr-to-NH₃ conversion by electrolysis, and (iii) formation of NH₃ and NH₃-based chemicals; and two optional components as the logical extension: (iv) direct NH₃ fuel cell, and (v) NH₃-mediated bicarbonate electrolysis, which is discussed in a U.S. provisional patent application entitled “A Membrane-Free Alkaline Electrolyzer for Upcycling Waste Into Ammonia,” filed the same day as the present disclosure, which is hereby incorporated by reference in its entirety. In a membrane-free alkaline electrolyzer (MFAEL) with NaOH/KOH/H₂O as the robust electrolyte, a record-high NH₃ partial current density of 4.22±0.25 A cm⁻² from NO₃⁻ reduction with a faradaic efficiency (FE) of 84.5±4.9% may be achieved on a simple commercial nickel foam as the cathode material. Continuous production of pure NH₃-based chemicals (NH₃ solution and solid NH₄HCO₃) was realized by collecting NH₃ by water and CO₂-saturated solutions, respectively, without the need for additional separation procedures. Low energy consumption can recover NO₃ from low concentration (100 ppm NO₃⁻—N) by efficient electrodialysis. Such an integrated process offers an all-sustainable and economically viable route for upcycling waste Nr into the highest-demanded N-based chemical product —NH₃, so that the growing trend of Nr buildup could be largely decelerated and reversed.

In some embodiments, the capturing is carried out according to the following formula:

CO₂+H₂O+NH₃→NH₄HCO₃.

In some embodiments, the converting the ammonium bicarbonate (NH₄HCO₃) into formate (HCOO⁻) is carried out in an integrated flow electrolyzer system with an anion exchange membrane to avoid using a bipolar membrane.

The term “electrolyzer,” as used herein, refers to an apparatus for performing electrolysis. An electrolyzer typically has a pair of electrodes (e.g., an anode and a cathode), a reaction medium (e.g., an electrolyte solution), and a power supply, which is typically an external source of power to add electrical energy to a reaction taking place in the reaction medium. The electrolyzer may or may not have a membrane dividing or separating the anode and the cathode. The electrodes facilitate the transfer of electrical energy into the reaction medium by extending into the reaction medium at one end and connecting to an external power supply at the other end. In the integrated flow electrolyzer system described herein, two or more electrolyzer units may be combined together with other units (e.g., a co-absorption unit to capture waste CO₂ by co-absorption of the waste CO₂ with ammonia (NH₃) to form ammonium bicarbonate (NH₄HCO₃)) to provide an integrated system for carrying out a series of chemical reactions.

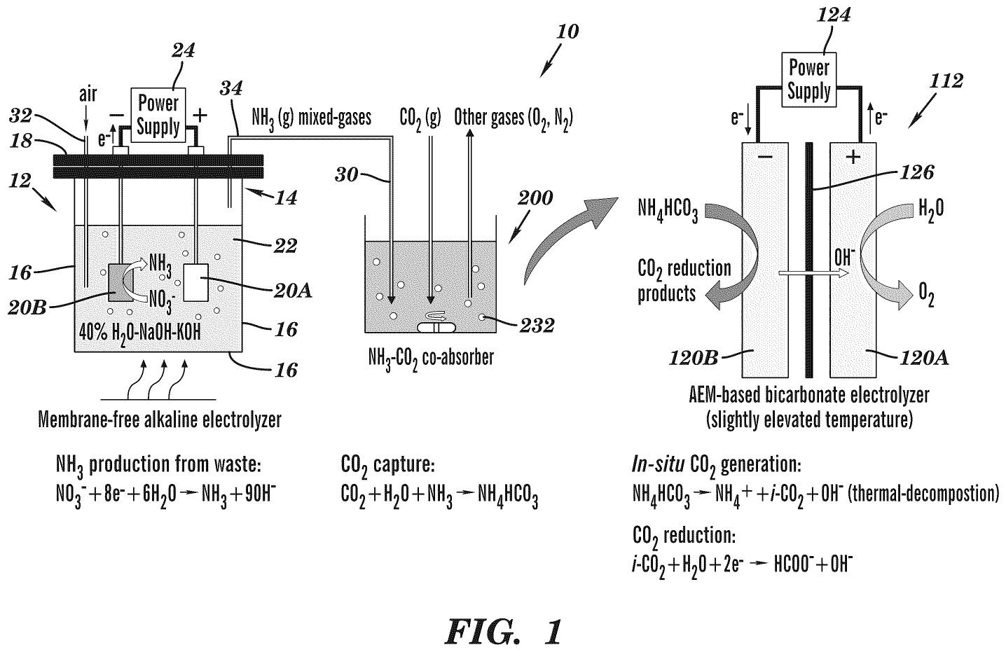

One embodiment of an integrated flow electrolyzer system comprising multiple units is illustrated in FIG. 1. In the particular embodiment illustrated in FIG. 1, an integrated process and system for CO₂ capture and utilization combines NH₃ production from NO₃ in a membrane-free alkaline electrolyzer, waste CO₂ capture by co-absorption with NH₃ in a co-absorber unit, and production of value-added commodity chemicals (formate) from a membrane-containing bicarbonate electrolyzer.

As illustrated in FIG. 1, integrated flow electrolyzer system 10 comprises alkaline electrolyzer 12 for producing NH₃ from NO₃⁻, which comprises reaction chamber 14 formed by walls 16 and lid 18, pair of electrodes 20A and 20B, which extend into reaction medium or electrolyte solution 22, and each is shown connected to power supply 24 (i.e., anode, positive electrode 20A connected to the positive terminal “+” of the power supply and cathode, negative electrode 20B connected to the negative terminal “−” of the power supply) and extending into reaction medium 22. Current from power supply 24 enters reaction medium 22 through anode 20A and leaves reaction medium 22 through cathode 20B. Air may enter electrolyzer 12 through intake 32, and NH₃ mixed gases may exit electrolyzer 12 through outtake 34.

In some embodiments, anode 20A and cathode 20B comprise nickel wire mesh, although other conductive materials and/or metals in other forms (e.g., metal foam) may also be used for the electrodes of the alkaline electrolyzer.

In some embodiments, the alkaline electrolyzer is a membrane-free alkaline electrolyzer. In some embodiments, the alkaline electrolyzer comprises an ion exchange membrane or other permeable membrane barrier.

In some embodiments, the integrated flow electrolyzer system comprises an alkaline electrolyzer, such as membrane-free alkaline electrolyzer 12 shown in FIG. 1 for producing NH₃ from NO₃⁻. In an alkaline electrolyzer, the reaction medium or electrolyte solution typically includes sodium hydroxide and/or potassium hydroxide and water. In some embodiments, the reaction medium comprises a concentrated NaOH—KOH solution (as an electrolyte) and electrodes made of commercial nickel wire mesh, although other reaction mediums and electrode materials may also be suitable, such as concentration of NaOH and KOH solution, and porous Raney nickel.

In some embodiments, chemical reactions occurring in the processes and systems described herein are carried out at elevated temperatures. For example, reaction mediums may be heated to a temperature above room temperature, or to temperatures of between 35-80° C., or any temperature or range of temperatures therein. In some embodiments, heating is carried out by applying a heat source to a particular reaction or reaction unit, such as an electrolyzer. With reference again to FIG. 1, heat source 128 is shown underneath electrolyzer 12 to heat reaction chamber 14 and reaction medium 22. In some embodiments, the reaction medium is heated to a temperature of 35-40° C., 35-45° C., 35-50° C., 35-55° C., 35-60° C., 35-65° C., 35-70° C., 35-75° C., 35-80° C., 40-45° C., 40-50° C., 40-55° C., 40-60° C., 40-65° C., 40-70° C., 40-75° C., 40-80° C., 45-50° C., 45-55° C., 45-60° C., 45-65° C., 45-70° C., 45-75° C., 45-80° C., 50-55° C., 50-60° C., 50-65° C., 50-70° C., 50-75° C., 50-80° C., 55-60° C., 55-65° C., 55-70° C., 55-75° C., 55-80° C., 60-65° C., 60-70° C., 60-75° C., 60-80° C., 65-70° C., 65-75° C., 65-80° C., 70-75° C., 70-80° C., or 75-80° C. In some embodiments, the reaction medium is heated to a temperature of 80° C. or more.

In some embodiments, the use of high alkalinity reaction medium and elevated temperature (e.g., 80° C.) in an alkaline electrolyzer in the integrated flow electrolyzer system of the present disclosure facilitates simultaneous NH₃ production and separation. Other conditions and reaction mediums can also be used to achieve the production of ammonium (NH₃).

In some embodiments, NO₃ reduction is carried out in a membrane-free alkaline electrolyzer of the integrated flow electrolyzer system of the present disclosure and is performed under a continuous flow of air. In some embodiments, the air in the continuous flow of air is N₂. In some embodiments, a continuous flow of air carries the produced NH₃ into a CO₂-saturated water solution, illustrated in FIG. 1 and discussed below as absorbing unit 200. In some embodiments, produced NH₃ is cooled at absorbing unit 200 to a temperature of 5° C., or 0-10° C., or any temperature or range therein suitable for NH₄HCO₃ formation.

Referring again to FIG. 1, integrated flow electrolyzer system 10 also includes a means of waste CO₂ capture by co-absorption with NH₃ from electrolyzer 12. This occurs in absorbing unit 200, where NH₃ from electrolyzer 12 flows from electrolyzer 12 through conduit 30 and is combined with waste CO₂ in co-absorber medium 232. As used herein, a “co-absorber” absorbs acidic CO₂ gas and basic NH₃ gas. In some embodiments, the co-absorber is water. In some embodiments, the co-absorber is saline water.

In the embodiment of integrated flow electrolyzer system 10 illustrated in FIG. 1, value-added commodity chemicals, such as formate, are derived from bicarbonate electrolyzer 112. In electrolyzer 12 of integrated flow electrolyzer system 10, air is used as a carrier gas to purge NH₃-containing gases out of reaction chamber 22 for its further capture of CO₂ in water in absorbing unit 200. Acid-base reaction between NH₃ and CO₂ (NH₃+CO₂+H2O→NH₄HCO₃) occurs in absorbing unit 200.

A third unit shown in integrated system 10 of FIG. 1 is bicarbonate electrolyzer 112, which is a membrane-containing electrolyzer comprising anode 120A, cathode 120B, and exchange membrane 126. Exchange membrane 126 is shown separating the two electrodes 120A and 120B. In some embodiments, the exchange membrane is an anion exchange membrane. An anion exchange membrane is a semipermeable membrane generally made from ionomers and designed to conduct anions while being impermeable to cations and gases such as oxygen or hydrogen. Anion exchange membranes are used in electrolytic cells to separate reactants present around the two electrodes while transporting the anions essential for the electrolyzer operation. In some embodiments, the exchange membrane is a cation exchange membrane. A cation exchange membrane is a semipermeable membrane generally made from ionomers and designed to conduct cations while being impermeable to anions and gasses such as oxygen or hydrogen. Cation exchange membranes are used in electrolytic cells and fuel cells to separate reactants present around the two electrodes while transporting the cations essential for the cell operation from the cathode to the anode.

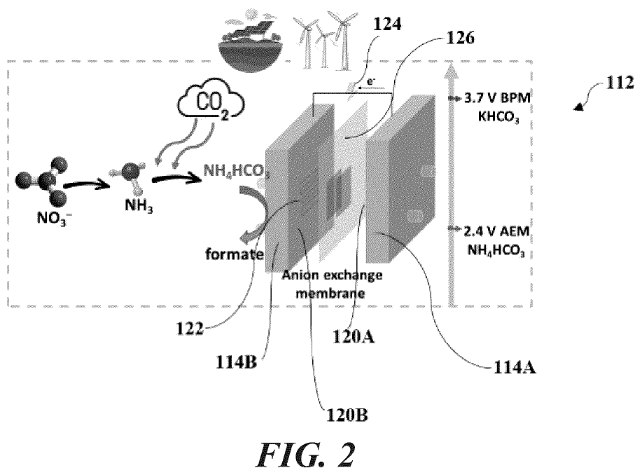

In the embodiment illustrated in FIG. 2, integrated flow electrolyzer system 10 (FIG. 1) comprises AEM-based bicarbonate electrolyzer 112, which comprises flow field plates 114A and 114B with serpentine flow channels 122 (also the reaction medium) embedded within field plates 114A and 114B allowing the flow of reaction medium 122, a pair of electrodes 120A and 120B, placed over flow channels 122 in direct contact with field plates 114A and 114B. Each electrode 120A and 120B of the pair is shown connected to power supply 124 (i.e., anode, positive electrode 120A connected to the positive terminal “+” of the power supply and cathode, negative electrode 120B connected to the negative terminal “−” of the power supply) and in contact with reaction medium 122, where electrodes 120A and 120B are separated by anion exchange membrane 126. Current from power supply 124 enters reaction medium 122 through anode 120A and exits reaction medium 122 through cathode 120B.

The above disclosure is general. A more specific description is provided below in the following examples. The examples are described solely for the purpose of illustration and are not intended to limit the scope of the present disclosure. Changes in the form and substitution of equivalents are contemplated as circumstances suggest or render expedient. Although specific terms have been employed herein, such terms are intended in a descriptive sense and not for the purposes of limitation.

### EXAMPLES

The following examples are provided to illustrate embodiments of the present application but are by no means intended to limit scope.

### Example 1—Ammonia-Mediated CO₂ Capture and Direct Electroreduction into Formate Materials and Methods

### Preparation of Electrodes

The electrodeposited-Bi (ED-Bi) was prepared in a two-electrode system in a one-compartment electrochemical cell by a modified method from literature (Li et al., “Conversion of Bicarbonate to Formate in an Electrochemical Flow Reactor.” ACS Energy Lett. 5(8):2624-2630 (2020), which is hereby incorporated by reference in its entirety). The aqueous Bi³⁺ precursor was prepared by adding 1.5 mmol of Bi(NO₃)₃·5H₂O into 40 mL of deionized water. Concentrated HNO₃ (5 mL) was added to the solution in order to fully dissolve the Bi precursor. The electrodeposition was conducted at a constant current of 72 mA for 5 min. A piece of carbon paper (3×3 cm², Freudenberg H23) and Pt foil were immersed in the electrolyte as cathode and anode, respectively.

### Materials Characterization

X-ray diffraction (XRD) crystallography was collected with a Siemens D500 diffractometer operated with a Copper K-α source (λ=1.5418 Å) at 45 kV and 30 mA and equipped with a diffracted beam monochromator (carbon). Scanning Electron Microscopy (SEM) was conducted on a field-emission scanning electron microscope (FEI Quanta-250) equipped with a light-element X-ray detector and an Oxford Aztec energy-dispersive X-ray analysis system.

### Electrochemical Measurements

### Electrochemical Conversion of CO₂ Captured Solutions in the Flow Cell

The flow electrolyzer contains two flow-field plates with serpentine channels, PTFE and silicone gaskets, and the membrane electrode assembly, which contains two electrodes and a membrane, and was formed after assembling the cell hardware. The anode (2.5×2.5 cm²) and cathode (2.0×2.0 cm²) flow plates were made from titanium and stainless steel, respectively. The catholyte and anolyte were circulated by a peristaltic pump (Masterflex® L/S®) at 50 mL min⁻¹. A piece of Ni foam (MIT corporation, 80-110 pores per Inch, average hole diameters about 0.25 mm) with geometric area of 6.25 cm² (2.5×2.5 cm²) and 40 mL of 1.0 M KOH were used as the anode and anolyte, respectively. The prepared ED-Bi on carbon paper and a 2.5 M of CO₂ capturing solution (i.e., NH₄HCO₃, KHCO₃, or MEA-CO₂) were used as the cathode and catholyte, respectively. The volume of catholyte was 40 mL and 120 mL for the current density of 100-150 mA cm⁻² and 200-300 mA cm⁻², respectively. A piece of bipolar membrane (Fumatech FBM), anion-exchange membrane (Tokuyama A201), or cation exchange membrane (Nafion115) was used as the ion exchange membrane. Argon was purged into the headspace of the catholyte for the on-line collection and off-line quantification of gaseous products (CO, H₂, and CO₂). The temperature of the flow cell was controlled by a 50-watt 110 V heater (Dioxide Materials).

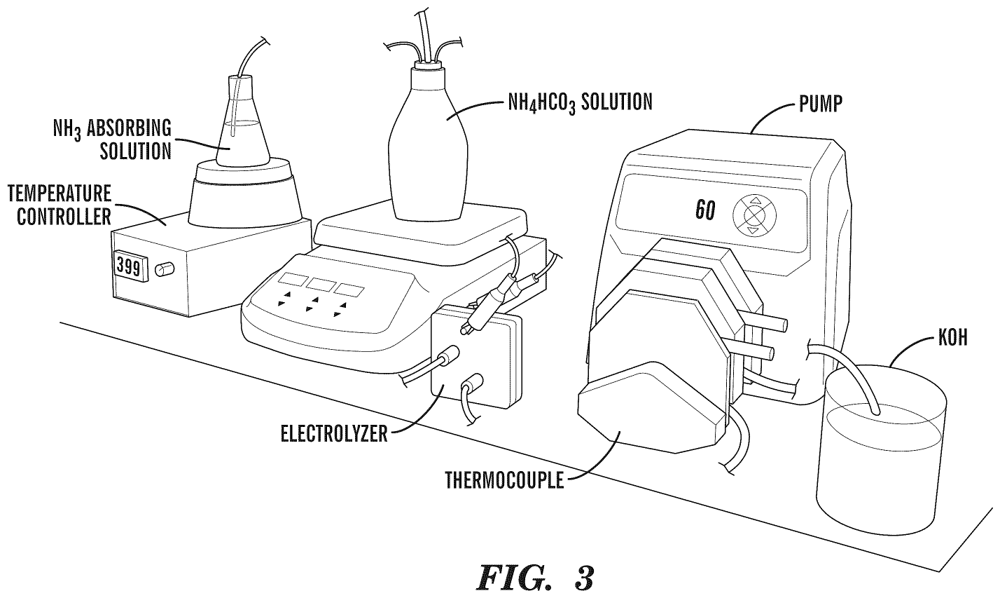

The 5-hour electrolysis was performed in a similar flow cell set-up with an anion-exchange membrane (Tokuyama A201). The photo of the experimental set-up is shown in FIG. 3. The volumes of catholyte and anolyte were 500 and 200 mL, respectively. The catholyte was directly connected to an NH₃ absorbing solution (0.2 M H₂SO₄, 200 mL). The formate concentration in both catholyte and anolyte was quantified by NMR spectroscopy at each hour interval, and the total absorbed NH₄⁺ in the absorbing solution was quantified after electrolysis.

Production of NH₄HCO₃ from CO₂ and nitrate (NO₃)-derived NH₃

The experimental setup for NH₄HCO₃ production comprises two major components connected in tandem (FIG. 3): an electrolyzer for NH₃ production by NO₃ electro-reduction, and an NH₄HCO₃ formation unit for the reaction between NH₃ and CO₂. The configuration of the one-compartment NH₃-producing electrolyzer was modified from our previous work (Chen et al., “Revealing Nitrogen-containing Species in Commercial Catalysts Used for Ammonia Electrosynthesis.” Nat. Catal. 3(12): 1055-1061 (2020), which is hereby incorporated by reference in its entirety). In brief, the cell body or reaction chamber comprised a 100 mL screw-cap polytetrafluoroethylene (PTFE) bottle and a custom-made stainless-steel lid. The electrolyte contained 29.7 g of NaOH, 48.1 g of KOH, and 38.9 g of deionized water (with 60 wt. % base with equimolar NaOH and KOH, and 40 wt. % of H₂O). 139.9 mmol of KNO₃ was added as the reactant. The cell was kept at 80° C.in an oil bath. Two 10 cm² nickel mesh electrodes (3.3×3 cm², 200 mesh) attached to nickel wires (0.04″ diameter) were used as the cathode and anode, and a flow of N₂ (200 mL min⁻¹) was bubbled into the electrolyte to carry the produced NH₃ into the NH₄HCO₃ formation unit, which comprised 100 mL of CO₂-saturated deionized water cooled to 5° C.and magnetically stirred at 400 r.p.m. To maintain the saturation of CO₂, 500 mL min⁻¹ of CO₂ was bubbled into the NH₄HCO₃ formation unit during the experiment. Electrolysis was carried out at a constant current density of 500 mA cm⁻² for 6 hours; under these conditions, the applied charge was equal to the theoretical amount of charge required to fully reduce NO₃ in the system to NH₃. To determine the utilization of NH₃ in the NH₄HCO₃ formation unit, the outlet gas from the NH₄HCO₃ formation unit was bubbled into an acidic solution (100 mL of 0.5 M H₂SO₄) to collect any unused NH₃.

To obtain solid NH₄HCO₃ sample for further i-CO₂RR experiments, a similar configuration with larger electrolyzer volume (2.5 L) was used with 25 times the quantity of all chemicals for electrolyte preparation. Other conditions include: 2.8 mol of added KNO₃ as the reactant, 100 cm² of the electrode area, 500 mL min⁻¹ of the N₂ flow rate, 250 mA cm⁻² of the applied current density, and 24 hours of the electrolysis duration. Due to the low solubility of NH₄HCO₃ (1.81 mol per liter of water at 5° C.), solid was precipitated in the NH₄HCO₃ formation unit, which was separated by vacuum filtration. The effective NH₄HCO₃ content of the collected sample was determined by dissolving a certain amount of the sample in deionized water, followed by measuring its NH₄⁺ concentration (detailed in the following section).

### Product Analysis

### Quantification of Soluble Products in the Electrolyte

Formate was quantified by ion chromatography (IC, Thermo Scientific Dionex Easion). 50 or 100 μL of the sample solution was diluted with deionized water and injected into IC for its quantification.

NO₃⁻ and NO₂⁻ were analyzed by High-Performance Liquid Chromatography (HPLC (Chou et al., “A High Performance Liquid Chromatography Method for Determining Nitrate and Nitrite Levels in Vegetables,” Journal of Food and Drug Analysis 11(3):233-238 (2003), which is hereby incorporated by reference in its entirety)) (Agilent Technologies, 1260 Infinity II LC System) equipped with a variable wavelength detector (Agilent 1260 Infinity Variable Wavelength Detector VL). The wavelength of 213 nm was used for detection. A C18 HPLC column (Gemini® 3 μm, 110Å, 100×3 mm) was used for analysis at 25° C. with a binary gradient pumping method to drive mobile phase at 0.4 mL min⁻¹. The mobile phase consisted of 0.01 M n-octylamine (for ion pairing) in a mixed solution containing 30 vol % of methanol and 70 vol % of DI water, and the pH of the mobile phase was adjusted to 7.0 with H₃PO₄. The running time was 30 min for each sample, and the retention time for NO₃ and NO₂⁻ was around 18 and 16 min, respectively. The calibration solutions for NO₃ or NO₂ were prepared with KNO₃ and KNO₂ in the concentration range of 0.0625-2 mM.

For the electrochemical NO₃ -to-NH₃ reaction, the conversion of NO₃⁻(X) and faradaic efficiency of product i (FEᵢ for NH₃ and NO₂) were calculated by

$$X = \frac{{n}_{0} - n}{{n}_{0}} \times 100 \%$$

$${FE}_{i} = \frac{{n}_{i} \cdot {z}_{i} \cdot F}{Q} \times 100 \%$$

where n₀ is the initial amount of NO₃ (mol); n is the amount of NO₃ after electrolysis (mol); nᵢ is the amount of product i (mol); zᵢ is the number of electrons transferred to product i; F is the Faraday constant (96,485 C mol⁻¹); Q is the total charge passed through the electrolytic cell (C).

NH₄₊ content was determined by ¹H Nuclear Magnetic Resonance (NMR) spectroscopy on a Bruker Avance NEO 400 MHZ NMR spectrometer. The sample solution was first diluted with 0.1 M H₂SO₄ to the proper range of NH₃ concentration. 800 μL of the diluted sample solution was then mixed with 200 μL of DMSO-d₆ and 200 μL of 32 μM maleic acid (internal standard) in DMSO-d₆. The scan number was 1,024 with a water suppression method. Standard NH₃ solutions were prepared for calibration with concentrations ranging from 0 to 5 mg L⁻¹ (in N).

### Quantification of Gas Products

The gas products were analyzed by an off-line gas chromatography (GC, SRI Instruments, 8610C, Multiple Gas #3) equipped with HayeSep D and MolSieve 5Å columns. A thermal conductivity detector was used to detect H₂, and a flame ionization detector was used to detect CO and CO₂. The calibration curves for H₂ (10-10,000 ppm, Cal Gas Direct), CO (110-8,000 ppm, Cal Gas Direct), and CO₂ (5,000 -50,000 ppm, Cal Gas Direct) were established by analyzing the calibration gases.

In the electrolysis of CO₂-capturing solutions at 5 min, 15 min, and 25 min, the outlet of the electrolyzer was connected to a standard FlexFoil sample bag (1 L, SKC INC) for on-line collection of gas products. Then, the collected gases were injected into GC for their off-line analysis. A 12-min GC program was applied. The rate of gas generation (r, mol s⁻¹) was calculated by

$$r = c \times 1 {0}^{- 6} \times \frac{p \dot{V} \times {10}^{- 6} / 60}{RT}$$

where c is the gas content (ppm); \dot{V} is the volumetric flow rate of the inlet gas to the sample bags (300 mL min⁻¹); p is the atmospheric pressure (1.013×10⁵ Pa); R is the gas constant (8.314 J mol⁻¹ K⁻¹); T is the room temperature (20° C. or 293.15 K). The total amount of gas production (mol) was calculated by integrating the plot of gas production rate (mol s⁻¹) vs. reaction time(s) with a linear fitting.

### Results and Discussion

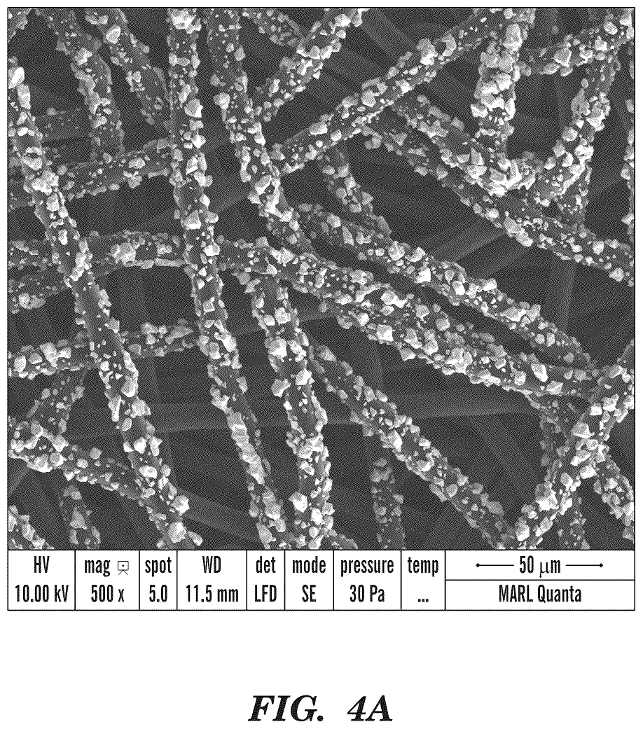

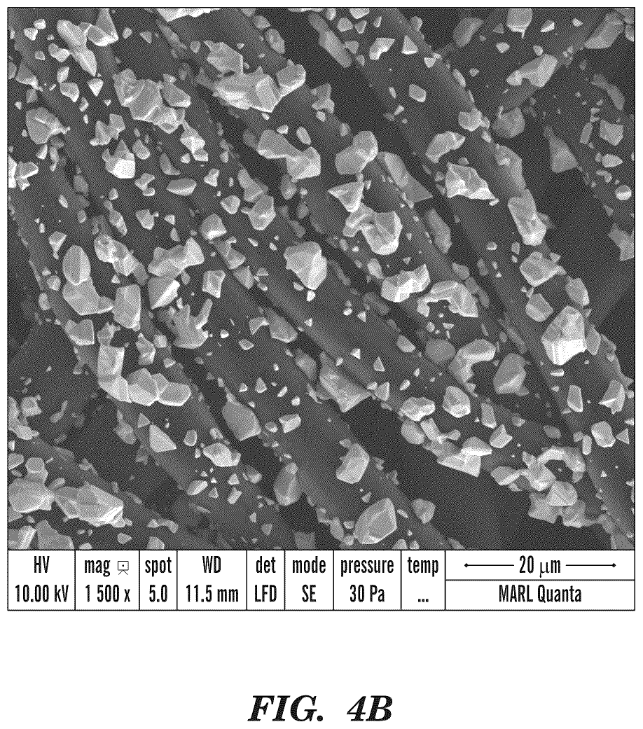

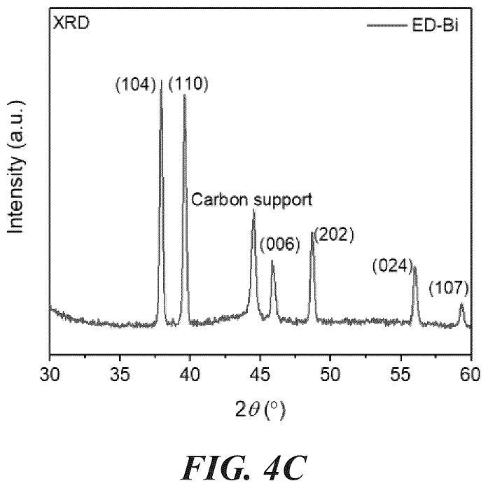

The i-CO₂RR performance in a BPM-based electrolyzer with NH₄HCO₃ as the electrolyte and reactant was first investigated. Formate was chosen as the target i-CO₂RR product in this study due to its known economic feasibility (De Luna et al., “What Would it Take for Renewably Powered Electrosynthesis to Displace Petrochemical Processes?,” Science 364(6438): eaav3506 (2019; Shin et al., “Techno-economic Assessment of Low-temperature Carbon Dioxide Electrolysis,” Nat. Sustain. 4(10):911-919 (2021); which are hereby incorporated by reference in their entirety). Besides, recent work has proposed that ammonium formate is a safe, and energy-dense electrochemical fuel ionic liquid with an energy density of 3.2 kWh/L, higher than that of formic acid and hydrogen (Schiffer et al., “Ammonium Formate as a Safe, Energy-Dense Electrochemical Fuel Ionic Liquid,” ACS Energy Lett. 7:3260-3267 (2022), which is hereby incorporated by reference in its entirety). Electro-deposited bismuth (ED-Bi) on a carbon paper substrate was used as the i-CO₂RR catalyst (Li et al., “Conversion of Bicarbonate to Formate in an Electrochemical Flow Reactor,” ACS Energy Lett. 5(8):2624-2630 (2020), which is hereby incorporated by reference in its entirety). Scanning electron microscopy (SEM) images and X-ray diffraction (XRD) pattern show the uniform deposition of metallic Bi on carbon paper (FIGS. 4A-C). The electrolyzer with a zero-gap configuration included the ED-Bi cathode, a BPM, and a piece of nickel foam as the anode. The catholyte and anolyte were supplied to their respective electrode compartment at an identical flow rate of 50 mL min⁻¹.

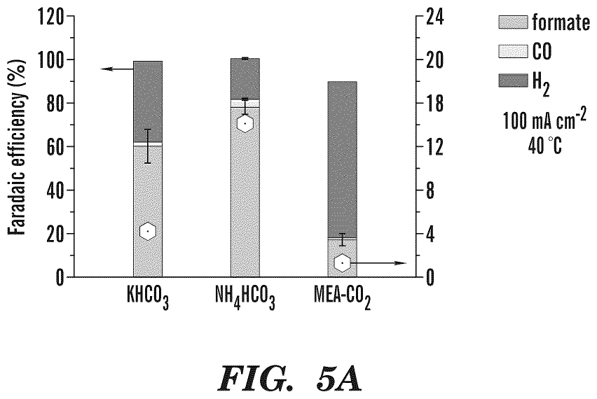

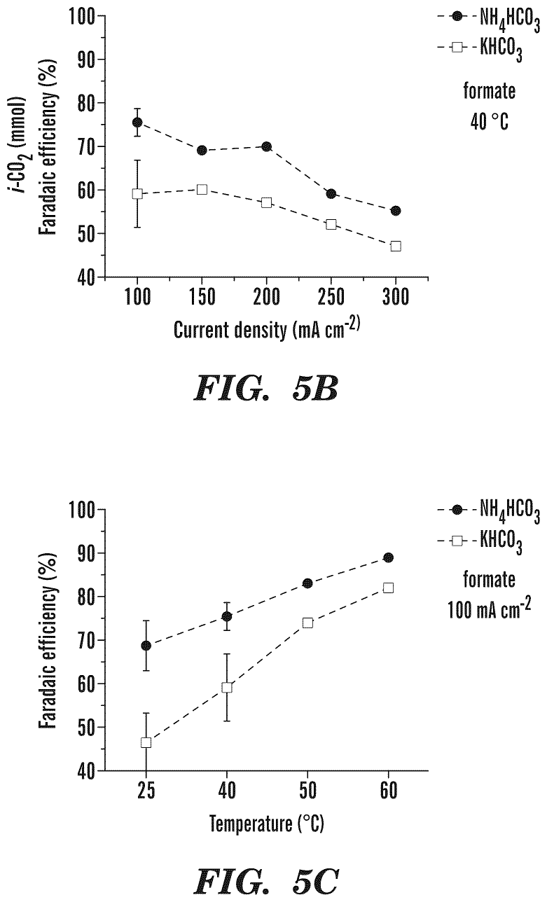

FIG. 5A shows the comparison of i-CO₂RR performance at 40° C.with three kinds of CO₂-capturing solutions (2.5 M for all cases): NH₄HCO₃, KHCO₃, and MEA-CO₂. At 100 mA cm⁻², the faradaic efficiency (FE) of formate production was 75+3% for NH₄HCO₃, much higher than that of KHCO₃ (59±7%) and MEA-CO₂ (18±3%). The main side reaction was the hydrogen evolution reaction (HER), and the FE towards CO production was less than 2%. Interestingly, the trend of FE towards formate is consistent with the amount of generated i-CO₂, which was determined by summing the amounts of CO₂ (evolved from the catholyte and detected by gas chromatography) and i-CO₂RR products generated during the electrolysis. The total i-CO₂ produced from NH₄HCO₃ was 3.4 or 10.8 times that of KHCO₃ or MEA-CO₂, respectively. The poor i-CO₂RR performance with MEA-CO₂ could be attributed to the bulky ions of MEA-CO₂ that inhibit i-CO₂ formation and transportation (Kim et al., “Insensitive Cation Effect on Single-atom Ni Catalyst Allows Selective Electrochemical Conversion of Captured CO₂ in Universal Media,” Energy & Environmental Science 15(10):DOI:10.1039/D2EE01825J (2022), which is hereby incorporated by reference in its entirety). Furthermore, by comparing the results with the corresponding control cells without applying current (Table 1), the portion of produced i-CO₂ from thermal decomposition was found to be 93% for NH₄HCO₃, much higher than that for KHCO₃ (52%), highlighting the ease of CO₂ release from NH₄HCO₃.

TABLE 1
The source of i-CO₂ in the BPM-based electrolyzers with KHCO₃ or
NH₄HCO₃ at cell temperature of 40° C. for half-hour operation.

| | | i-CO₂ from | i-CO₂ from BPM- |
|---|---|---|---|
| | | thermo- | induced chemical |
| | Total i-CO₂ | decomposition | decomposition |
| System | (mmol)^{a} | (mmol)^{b} | (mmol)^{c} |
| KHCO₃ | 4.2 | 2.2 | 2.0 |
| NH₄HCO₃ | 14.1 | 12.5 | 1.6 |

^{a}Total i-CO₂ values were determined by summing the amounts of both CO₂ and i-CO2RR products generated from the cathode during the half-hour electrolysis.
^{b}The values of i-CO₂ from thermo-decomposition were obtained from the same BPM-based electrolyzer without applying any current
^{c}The i-CO₂ values from BPM-induced chemical decomposition were obtained from subtracting the “i-CO₂ from thermo-decomposition” from the “total i-CO₂”.

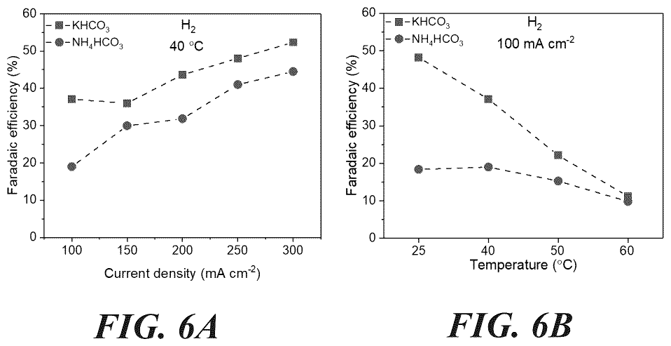

The i-CO₂RR performances of the systems with NH₄HCO₃ and KHCO₃ were further compared at different current densities ranging from 100 to 300 mA cm⁻² (FIG. 5B) and cell temperatures from 25 to 60° C.(FIG. 5C). The system with NH₄HCO₃ shows 10-20% higher formate-oriented FE than KHCO₃ under all tested conditions. Limited by the mass transport limit of i-CO₂, the remaining FE attributed to the competing H₂ (major) and CO (minor, <2%) evolutions, which exhibited an opposite trend as compared to formate formation (FIGS. 6A-B and Table 2). At 100 mA cm⁻², the highest formate FE was 90% with NH₄HCO₃ at 60° C., which is higher than the reported values in the bicarbonate electrolyzers for formate production (Li et al., “Conversion of Bicarbonate to Formate in an Electrochemical Flow Reactor,” ACS Energy Lett. 5(8):2624-2630 (2020); Min and Kanan, “Pd-catalyzed Electrohydrogenation of Carbon Dioxide to Formate: High Mass Activity at Low Overpotential and Identification of the Deactivation Pathway,” J. Am. Chem. Soc. 137(14):4701-4708 (2015); which are hereby incorporated by reference in their entirety).

TABLE 2
Summary of the faradaic efficiencies of i-CO₂ reduction
products in the BPM-based electrolyzers with KHCO₃ or NH₄
HCO₃ at different reaction conditions.

| | | | | FE | |
|---|---|---|---|---|---|
| | | FE towards | FE towards | towards | Total |
| | Conditions | H₂ (%) | formate (%) | CO (%) | (%) |
| KHCO₃ | 100 mA/cm² | 37.11 | 59.50 | 1.96 | 98.57 |
| (40° C.) | 150 mA/cm² | 36.02 | 60.00 | 1.74 | 97.76 |
| | 200 mA/cm² | 43.64 | 56.64 | 1.81 | 102.09 |
| | 250 mA/cm² | 48.04 | 51.88 | 1.57 | 101.49 |
| | 300 mA/cm² | 52.32 | 46.93 | 1.50 | 100.75 |
| | 100 mA/cm² | 18.98 | 79.49 | 3.45 | 101.92 |
| NH₄HCO₃ | 150 mA/cm² | 29.96 | 69.33 | 2.76 | 102.05 |
| (40° C.) | 200 mA/cm² | 31.84 | 69.83 | 3.00 | 104.67 |
| | 250 mA/cm² | 41.00 | 59.16 | 2.06 | 102.22 |
| | 300 mA/cm² | 44.50 | 54.81 | 2.39 | 101.70 |
| KHCO₃ | RT (25° C.) | 48.18 | 54.99 | 2.06 | 105.23 |
| (100 mA | 50° C. | 22.10 | 74.50 | 2.79 | 99.39 |
| cm⁻²) | 60° C. | 11.20 | 82.11 | 3.36 | 96.67 |
| NH₄HCO₃ | RT (25° C.) | 18.37 | 76.92 | 2.60 | 97.89 |
| (100 mA | 50° C. | 15.26 | 82.58 | 3.72 | 101.56 |
| cm⁻²) | 60° C. | 9.81 | 89.00 | 4.08 | 102.89 |

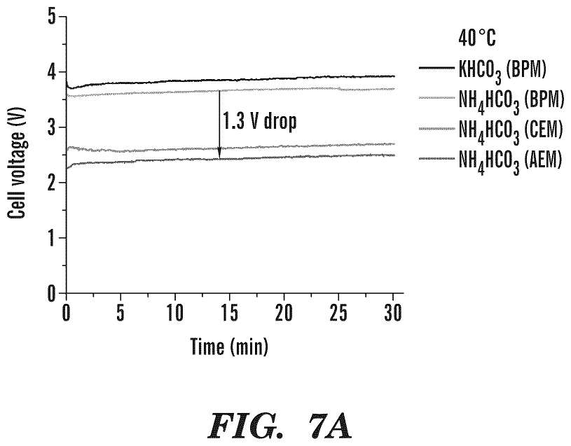

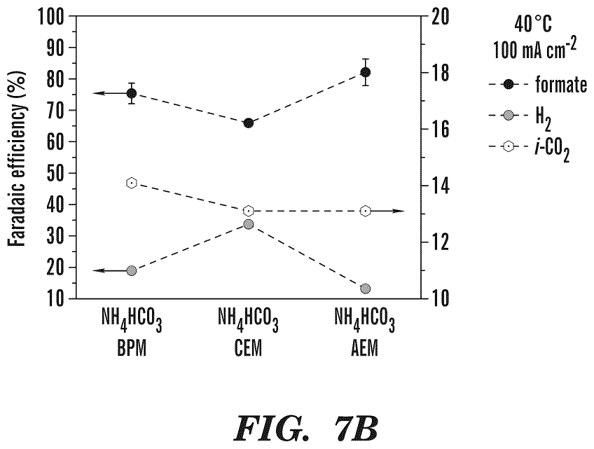

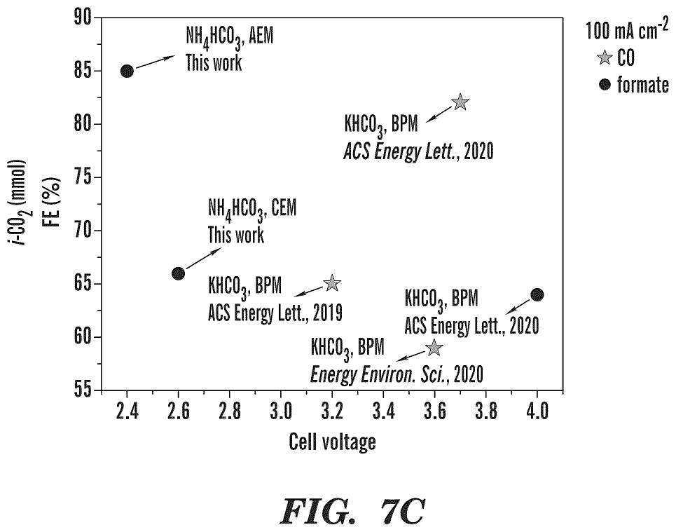

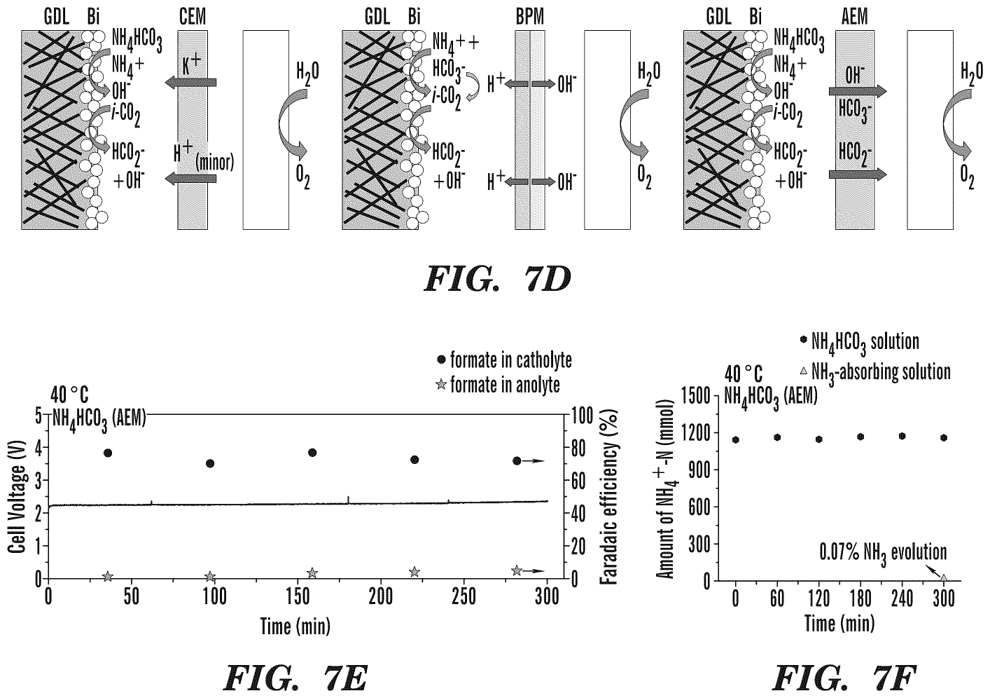

Since the thermal decomposition dominates the production of i-CO₂ from NH₄HCO₃ (compared to the minor contribution from BPM), it was further sought to remove the energy-consuming BPM in the electrolyzer to reduce the cell voltage. As shown in FIG. 7A, substituting BPM with CEM or AEM indeed resulted in a decrease in the cell voltage from 3.7 V to 2.4 V. FIG. 7B compares the i-CO₂RR performances with NH₄HCO₃ feed using BPM, CEM, and AEM as the membrane. The i-CO₂ production only decreased slightly as the BPM was replaced by CEM or AEM due to the absence of H⁺ from BPM by water dissociation. In particular, when AEM is used, HER can be largely suppressed to 13% under a relatively high local pH (FIG. 7D), resulting in a maximum formate FE of 82±4% among the systems with three membranes. It is worth noting that the possible crossover of formate in three membrane cases was taken into account, and the total FE was calculated by summing the formate concentration in both catholyte and anolyte. No formate crossover in the CEM- and BPM-based eletrolyzers was observed, and the percentage of its crossover in the AEM-based system was 4.7% (Table 3).

TABLE 3
The detection of crossover in the
NH₄HCO₃ systems with three membranes.[a]

| | Formate in Catholyte | Formate in anolyte | Crossover |
|---|---|---|---|
| System | (mM) | (mM) | percentage (%) |
| BPM | 74.13 | None | 0 |
| CEM | 61.99 | None | 0 |
| AEM | 75.21 | 3.75 | 4.7 |

[a]The electrolysis was performed at 100 mA cm⁻² for half-hour.

The above results demonstrate that replacing BPM with AEM for the NH₄HCO₃ electrolyzer not only reduces the energy consumption significantly, but also increases the FE towards formate due to the favorable microenvironments at the electrode-membrane interface. The results are in stark contrast to the reported bicarbonate electrolyzer with KHCO₃ feed (Li et al., “Conversion of Bicarbonate to Formate in an Electrochemical Flow Reactor,” ACS Energy Lett. 5(8):2624-2630 (2020), which is hereby incorporated by reference in its entirety), in which AEM showed a lower performance (<20% formate FE) compared to BPM (62% formate FE): in that case, generation of i-CO₂ almost solely relies on the H⁺ supply from the membrane owing to the sluggishness of the thermal decomposition of KHCO₃. As shown in FIG. 7C, the performance of the NH₄HCO₃ electrolyzer used here is superior to the state-of-the-art bicarbonate electrolyzers in terms of cell voltage and FE.

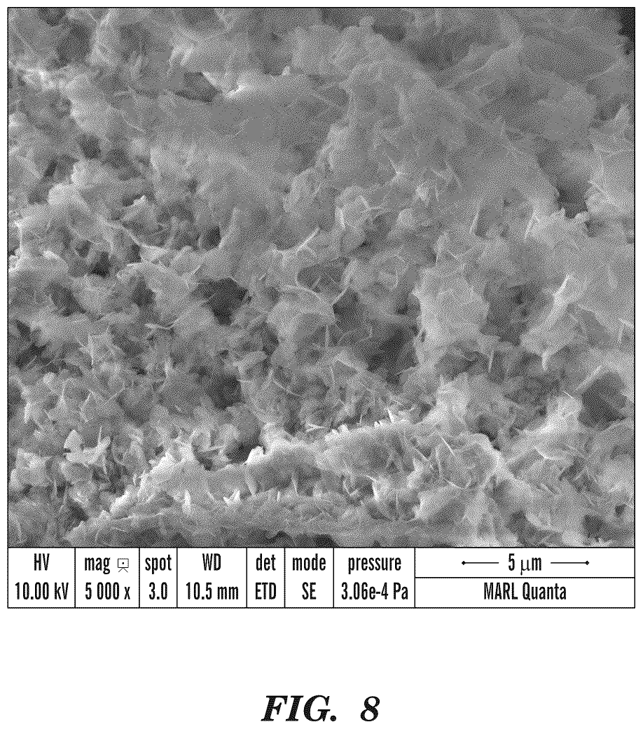

To investigate the volatility of NH₃ in the NH₄HCO₃-based electrolyzer, a 5-hour electrolysis was conducted in the AEM-based system and NH₃ loss during electrolysis was quantified (FIG. 3). In theory, in the aqueous electrolyte with buffered NH₄HCO₃ solution, NH₄⁺ (aq) is the dominating species (detailed analysis in Example 2, infra). Indeed, at 100 mA cm⁻², negligible NH₃ loss was observed in the electrolyzer, since the amount of NH₄⁺ (aq) was virtually unchanged in the NH₄HCO₃ solution at each hour interval and the escaped NH₃ was merely 0.07% (in NH₄⁺ equivalent) among the total NH₄HCO₃ detected in the NH₃-absorbing solution (FIG. 7F). A very stable cell voltage was observed at 2.2 V throughout the entire electrolysis, and the total formate FE (catholyte+anolyte) varied in a narrow range between 74% and 79% (FIG. 7E), both of which indicate the stable operation of the NH₄HCO₃ electrolysis with AEM. A slight increase in the cross-over of formate to anolyte was observed during 5-hour electrolysis. This was attributed to the gradual increase in the concentration gradient of formate between catholyte and anolyte. Even so, the total crossover was still <5% after 5 hours. SEM image (FIG. 8) showed that Bi catalyst maintained a nano-sized structure, where the morphology of nanosheets were likely formed from the in-situ transformation from Bi nanoparticles under the electrolysis conditions (Lee et al., “Bismuth Nanosheets Derived by In Situ Morphology Transformation of Bismuth Oxides for Selective Electrochemical CO₂ Reduction to Formate,” ACS Appl. Mater. Interfaces. 14(12): 14210-14217 (2022); Han et al., “Ultrathin Bismuth Nanosheets from In situ Topotactic Transformation for Selective Electrocatalytic CO₂ Reduction to Formate,” Nat. Comm. 9(1): 1-8 (2018); which are hereby incorporated by reference in their entirety).

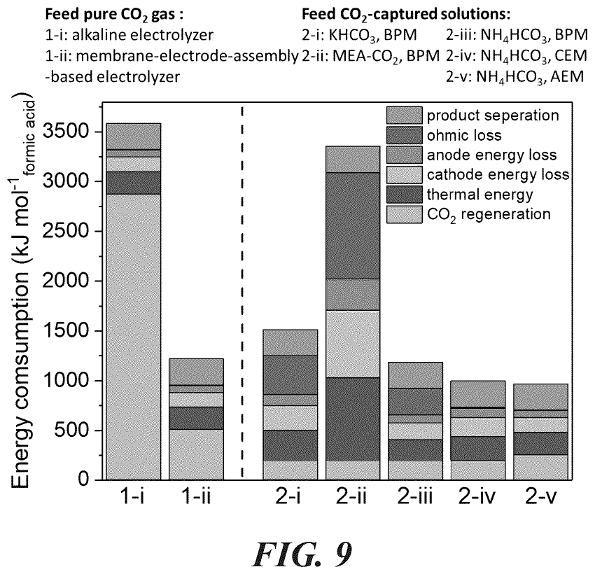

To quantitatively compare the energy consumption of CO₂RR in different cell configurations, the breakdown of energy consumption for formic acid production at the current density of 100 mA cm⁻² was analyzed (detailed calculation methods are described in Example 3, infra). As shown in FIG. 9, for the systems with gaseous CO₂ feed (cases 1-i and 1-ii), the majority of energy consumption arises from the regeneration of CO₂, leading to higher total energy consumption than the systems fed with CO₂ capture solutions. Compared with other cases, conversion of MEA-CO₂ solution (case 2-ii) requires additional input of electrical energy owing to its low FE towards the desired product. The lowest energy consumption was corresponding to the systems with NH₄HCO₃ feed following the order of AEM<CEM<BPM (cases 2-iii to 2-v), in accordance with the experimental data provided here.

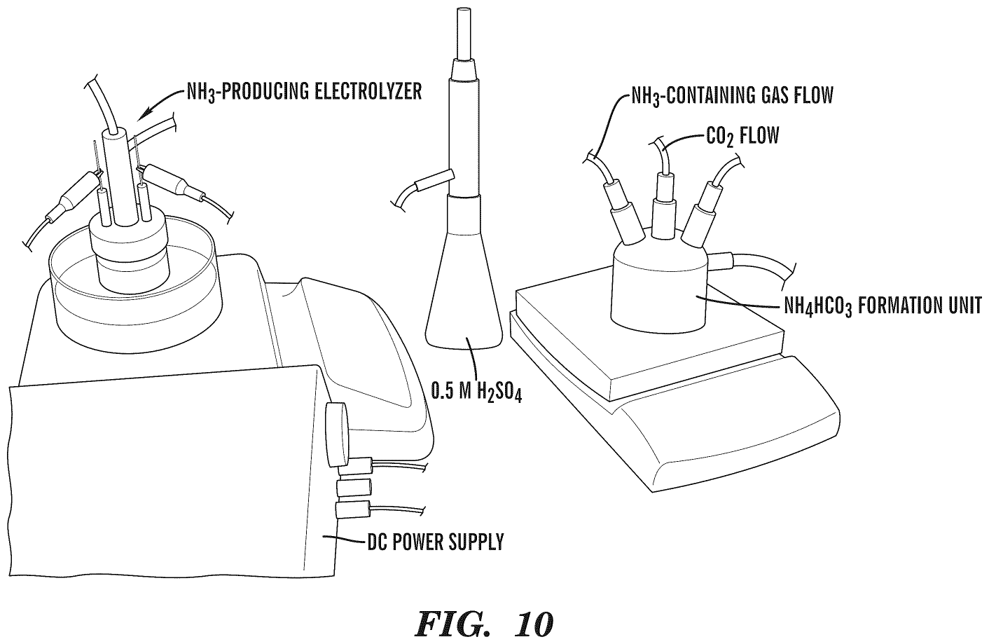

Apart from the ease of CO₂ release, another key advantage of NH₃-based CO₂ capturing is that NH₃ can be sustainably produced from wastes. As NO₃ ⁻—N is a major form of pollutants in wastewater (Temkin et al., “Exposure-based Assessment and Economic Valuation of Adverse Birth Outcomes and Cancer Risk Due to Nitrate in United States Drinking Water,” Environ. Res. 176:108442 (2019), which is hereby incorporated by reference in its entirety), its electrochemical reduction offers a sustainable pathway to NH₃ as a waste-derived CO₂ capturing agent, while alleviating the environmental impact of NO₃ itself. For this purpose, an integrated system comprising an electrolyzer for NH₃ production and an absorbing unit for capturing CO₂ was developed (FIG. 10). The NH₃-producing electrolyzer was modified from the configuration in previous work (Chen et al., “Revealing Nitrogen-containing Species in Commercial Catalysts Used for Ammonia Electrosynthesis,” Nat. Catal. 3(12):1055-1061 (2020), which is hereby incorporated by reference in its entirety), which contains a concentrated NaOH—KOH solution as the electrolyte and commercial nickel wire mesh as the electrodes. The use of high alkalinity and elevated temperature (80° C.) facilitated simultaneous NH₃ production and separation. NO₃⁻ reduction was performed under a continuous flow of N₂, which carries the produced NH₃ into a CO₂-saturated water solution cooled at 5° C. for NH₄HCO₃ formation.

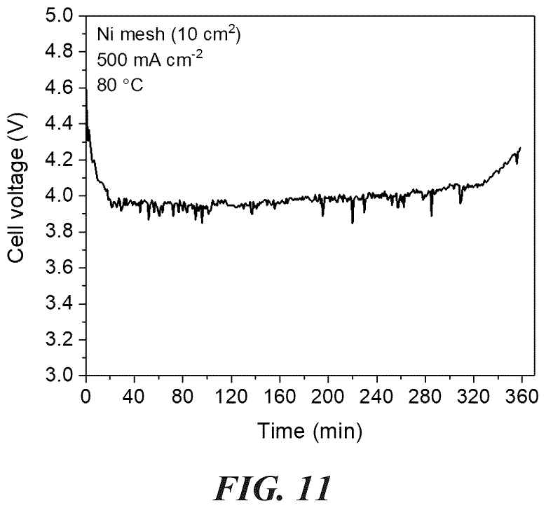

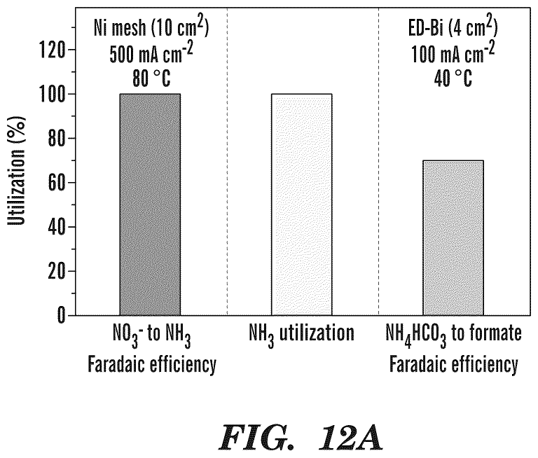

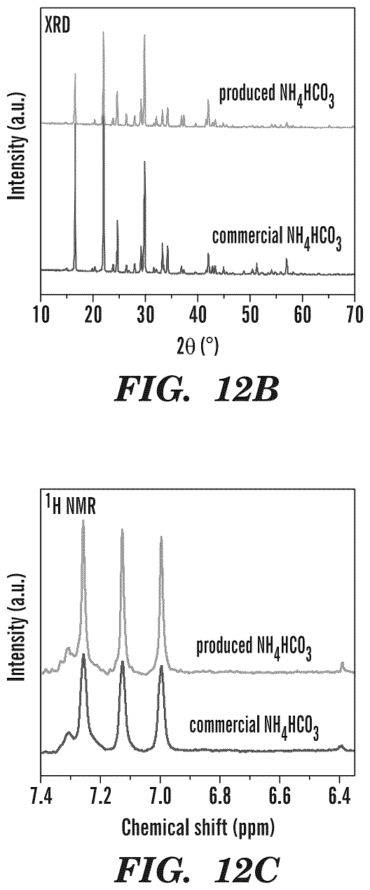

Electrolysis was performed at 500 mA cm⁻² for 6 hours with the supply of theoretical charge of NO₃⁻ to-NH₃ reaction (FIG. 11), yielding a NH₄HCO₃ solution with a concentration of 1.21 M in the integrated NO₃⁻-to-NH₄HCO₃ system. For NO₃ electrolysis, FIG. 12A showed the FE of NH₃ production was 99.5% with the nearly complete conversion of NO₃⁺ (98.8%), while the FE of the side-product NO₂ was only 0.06%. For the CO₂ capturing unit, only a trace amount of NH₃ evolution (0.2% of the total NH₃ generated) was detected from its outlet, suggesting its high utilization of NH₃ as the on-site generated CO₂ capturing agent. The low boiling point (−33.34° C.) of ammonia and its high vapor pressure in the alkaline environment, as well as its high pKₐ (acid-base reaction between NH₃ and CO₂ in water: NH₃⁺ CO₂+H₂O→NH₄HCO₃) have guaranteed the simultaneous NH₃ generation, separation, and CO₂ capturing.

Further extending the electrolysis duration in a scaled-up reactor led to the precipitation of solid NH₄HCO₃. The crystal phase of the separated solid was confirmed by comparing the XRD pattern with the commercial NH₄HCO₃ product (FIG. 12B). In the BPM-based bicarbonate electrolyzer, electrolysis with the as-prepared NH₄HCO₃ showed a formate FE of 70%, which is close to the result with commercial NH₄HCO₃ (FE: 79%) under identical conditions. The slightly lower performance is possibly because of its lower effective NH₄HCO₃ content (91.4%, determined by ¹H NMR spectroscopy as shown in FIG. 12C) due to the incorporation of water during its precipitation. Such a tandem process can effectively “seal” the waste nitrogen and waste carbon into NH₄HCO₃ as a stable, pure, and easy-to-handle chemical product. Benefiting from the highly reversible nature of NH₄HCO₃ formation and decomposition, waste N-derived NH₃ can “shuttle” the waste CO₂ for its electrochemical conversion by the CO₂ capture-release cycling process.

In summary, the study described herein demonstrated that NH₄HCO₃ can serve as a unique, highly reactive platform that bridges CO₂ capturing and its electrochemical conversion via its facile in situ release. In this regard, NH₄HCO₃ has shown more desirable i-CO₂RR performance compared to KHCO₃ and MEA-CO₂ owing to its much lower energy requirement for releasing i-CO₂ within the electrolyzer. A mildly elevated temperature was proven sufficient for generating adequate i-CO₂ for its efficient electro-reduction with negligible ammonia loss, lifting the requirement of the energy-consuming BPM in the cell system, and thus providing a proper solution to the high cell voltage of the prevailing electrolyzers for CO₂ capture solutions. The highly selective produced ammonium formate can be used as an appealing candidate as energy carrier (Schiffer et al., “Ammonium Formate as a Safe, Energy-Dense Electrochemical Fuel Ionic Liquid,” ACS Energy Lett. 7:3260-3267 (2022), which is hereby incorporated by reference in its entirety).

### Example 2—Ammonia Loss Analysis

The pH of the cathode electrolyte the dominance of NH₄⁺: The system (2.5 M NH₄HCO₃) has a mild and stable alkalinity, pH=7.8, which can be seen in the Handbooks in Separation Science-Capillary Electromigration Separation Methods (Poole, C. F., Capillary Electromigration Separation Methods. Elsevier: 2018, which is hereby incorporated by reference in its entirety). The pH of NH₄HCO₃ aqueous solutions is in the middle between pKa of NH₄⁺ (9.26) and pKa of HCO₃⁻ (6.35). Therefore, NH₄⁺ indeed is the dominating species (96.6% of all nitrogen at 25° C.) in the NH₄⁺(aq)/NH₃(aq) equilibrium.

The two equilibria: One is the NH₃(g)/NH₃(aq) equilibrium, and the other is the NH₄⁺(aq)/NH₃(aq) equilibrium. The two equilibria are independent and subject to different equilibrium constants: The first is governed by the Henry's law, and the second is controlled by the solution pH. In our cathode electrolyte (2.5 M NH₄HCO₃), the maximum partial pressure of NH₃(gas) on the immediate surface of the solution is merely 98.6 Pa (or ˜0.1vol. %), based on the Henry's constant at 25° C. (69 mol/(kg bar)). NH₃ loss was not observed in the experiments using 2.5 M NH₄HCO₃.

### Example 3—Energy Consumption Estimation

the energy consumption for CO₂ reduction toward formate was calculated in different well-known cell configurations:
(1) Feed pure CO₂ gas:
(1-i) gas and liquid feed-alkaline flow electrolyzer
(1-ii) gas-feed membrane electrode assembly flow electrolyzer
(2) Feed CO₂ capture solutions:
(2-i) KHCO₃ feed into bipolar membrane (BPM)-based electrolyzer
(2-ii) MEA-CO₂ feed into BPM-based electrolyzer
(2-iii) NH₄HCO₃ feed into BPM-based electrolyzer
(2-iv) NH₄HCO₃ feed into cation exchange membrane (CEM)-based electrolyzer
(2-v) NH₄HCO₃ feed into anion exchange membrane (AEM)-based electrolyzer HER was assumed as the only side reaction. The current density was assumed at 100 mA cm⁻².

CO₂ regeneration. In the conventional cases by feeding purified CO₂, significant energy input is required to regenerate CO₂ through a few thermal and compression steps (Keith et al., “A Process for Capturing CO₂ From the Atmosphere,” Joule 2(8): 1573-1594 (2018); Welch et al., “Bicarbonate or Carbonate Processes for Coupling Carbon Dioxide Capture and Electrochemical Conversion,” ACS Energy Lett. 5(3):940-945 (2020); which are hereby incorporated by reference in their entirety). From a typical calcium caustic recovery loop, the energy consumption for CO₂ regeneration (CaCO₃→CaO+CO₂) is 178.3 KJ/mol_{CO2} (Keith et al., “A Process for Capturing CO₂ From the Atmosphere,” Joule 2(8): 1573-1594 (2018), which is hereby incorporated by reference in its entirety).

In the alkaline electrolyzer (i-1), the major loss of CO₂ could be due to the combination (or alkaline hydration) reaction (CO₂+OH⁻→HCO₃⁻) and the crossover of bicarbonate from the cathode to the anode. Based on the previous literature (Dinh et al., “CO2 Electroreduction to Ethylene Via Hydroxide-mediated Copper Catalysis at an Abrupt Interface,” Science 360(6390): 783-787 (2018); Gu et al., “Modulating Electric Field Distribution by Alkali Cations for CO2 Electroreduction in Strongly Acidic Medium,” Nat. Catal. 5(4): 1-9 (2022); which are hereby incorporated by reference in their entirety), a model can be built to estimate the CO₂ consumption. At the steady state, the rate of CO₂ supply (through diffusion) is equal to that of CO₂ combination reaction in the nearby region of the cathode:

$${D}_{CO 2} \frac{{d}^{2} c}{{dx}^{2}} = k \cdot c \cdot [ {OH}^{-} ]$$

where D_{CO2} is the diffusion coefficient of CO₂ in water (1.91×10⁻⁹ m²·s⁻¹), c is the CO₂ concentration in electrolyte (M), x (m) is the distance between an electrolyte location and the gas-solution interface, k is the rate constant for the combination reaction (CO₂+OH⁻→HCO₃⁻, 2.23 mol⁻¹·m³·s⁻¹), and [OH⁻] is the concentration of OH⁻ (a constant 1 M assumed in this work). Solving the equation by integration and considering the boundary conditions (c=c₀, or interfacial CO₂ concentration, when x=0; and c=0, when x=∞), the following expression can be obtained:

$$c = {c}_{0} \cdot exp ( - \sqrt{\frac{k [ {OH}^{-} ]}{{D}_{CO 2}}} \cdot x )$$

where c₀ is the interfacial CO₂ concentration in the electrolyte at the gas-solution interface, which is assumed as the CO₂ solubility (0.038 M understand the standard conditions) in water. The CO₂ consumption rate due to the combination reaction (Jₕ), which is the flux of CO₂ across the gas-solution interface, is calculated, as follows:

$${J}_{h} = - {D}_{CO 2} \cdot \frac{dc}{dx} {\vert}_{x = 0} = {c}_{0} \cdot \sqrt{k \cdot {D}_{CO 2} [ {OH}^{-} ]} = 7.84 \times 1 {0}^{- 6} mol \cdot {s}^{- 1} \cdot {cm}^{- 2}$$

The CO₂ consumption due to its reduction reaction at 100 mA cm⁻² is calculated, as follows:

$${J}_{r} = \frac{n \cdot {j}_{CO 2}}{z \cdot F} = \frac{1 \cdot 0.1}{2 \cdot 96485} = 5.18 \times 1 {0}^{- 7} mol \cdot {s}^{- 1} \cdot {cm}^{- 2}$$

where j_{CO2} is the partial current density of CO₂ reduction, n is the number of required CO₂ molecules for one molecular formate produced (n=1 here), z is the number of electrons involved in the CO₂-to-formate reaction, and F is the Faraday constant (96,485 C·mol⁻¹). Then, the CO₂ utilization in the alkaline electrolyzer (1-i) is calculated, as follows:

CO₂ utilization=Jᵣ/(Jᵣ+Jₕ)=6.2%

Membrane electrode assembly-based flow electrolyzers by using AEM suffer from a ˜30% CO₂ loss due to the bicarbonate crossover from cathode to anode (Weng et al., “Towards Membrane-electrode Assembly Systems for CO2 Reduction: A Modeling Study,” Energy Environ. Sci. 12(6): 1950-1968 (2019); Lee et al., “Electrochemical Upgrade of CO2 From Amine Capture Solution,” Nat. Energy 6(1):46-53 (2021); which are hereby incorporated by reference in their entirety), regardless of feeding with either a humidified pure CO₂ gas (1-ii) or circulating aqueous NH₄HCO₃ (2-v). In addition, when feeding pure CO₂ into the MEA cell, there is an additional ˜35% CO₂ loss due to the escape of unreacted CO₂ (Lee et al., “Electrochemical Upgrade of CO₂ From Amine Capture Solution,” Nat. Energy 6(1):46-53 (2021), which is hereby incorporated by reference in its entirety). As such, the CO₂ utilization in the MEA-based electrolyzers with AEM can be estimated as 35% and 70% when feeding gaseous CO₂ and aqueous NH₄HCO₃, respectively.

By contrast, 90% of CO₂ utilization can be assumed for the cases of using BPM or CEM when feeding CO₂ capture solutions (2-i, 2-ii, 2-iii, and 2-iv), by avoiding the bicarbonate crossover between electrodes and the gas escape at cathode (Lee et al., “Electrochemical Upgrade of CO2 From Amine Capture Solution,” Nat. Energy 6(1):46-53 (2021); Li et al., “CO2 Electroreduction From Carbonate Electrolyte,” ACS Energy Lett. 4(6): 1427-1431 (2019); which are hereby incorporated by reference in their entirety).

TABLE 4
Summary of CO₂ consumption and utilization for all cases.

| | CO₂ consumption | | | | |
|---|---|---|---|---|---|
| | Combination | HCO₃— | Unreacted | | Total CO₂ |
| Case | reaction | crossover | escape | Total | utilization |
| 1-i | 93.8% | | | 93.8% | 6.2% |
| 1-ii | | 30% | 35% | 65% | 35% |
| 2-i | | | | 0% | 90% |
| 2-ii | | | | 0% | 90% |
| 2-iii | | | | 0% | 90% |
| 2-iv | | | | 0% | 90% |
| 2-v | 30% | | | 30% | 70% |

Thus, the energy consumption for CO₂ regeneration is shown as follows: CO₂ regeneration energy=(178.3 KJ/mol)/(CO₂ utilization)

### Thermodynamic Energy

In the AEM-based eletrolyzer through NH₄HCO₃ feed (case 2-v), the cathodic electrolyte is 2.5 M NH₄HCO₃, and the anodic electrolyte is 1 M KOH. An AEM separates the cathodic and anodic electrolytes.

### 1. Estimation of Catholyte pH During Electrolysis

The catholyte is 40 mL of 2.5 M NH₄HCO₃ and acts as a buffer. The total amount of NH₄HCO₃ before thermodynamic equilibrium is 40×2.5=100 mmol. At the equilibrium, the pH of the 2.5 M NH₄HCO₃ is ˜7.80 (i.e., the middle point between the two pKa values: 6.35 of H₂CO₃ and 9.25 of NH₄⁺, CRC handbook). Therefore, the amounts of NH₄⁺ and NH₃ are 96.45 mmol (96.45% of N) and 3.55 mmol (3.55% of N), respectively, based on the Henderson-Hasselbalch equation: pH=pKₐ(NH₄⁺)+log₁₀([NH₃]/[NH₄⁺]) and the mass conservation ([NH₃]+[NH₄⁺]=100 mmol), where [NH₃] and [NH₄⁺] are concentrations of NH₃ and NH₄⁺, respectively.

The cathodic reaction is

CO₂+2e⁻+H₂O→HCOO⁻+OH⁻

After electrolysis at 400 mA (100 mA cm⁻²) for 30 min, the cathodic reaction generates 3.7 mmol of OH⁻ (assuming 100% FE to HCOO⁻), and this OH⁻ should react with and thus turn 3.7 mmol NH₄⁺ to NH₃. Based on the measurement of i-CO₂, the total decomposed NH₄HCO₃ should be 14.1 mmol. So, the remaining NH₄⁺ is 96.45−3.7−14.1×96.45%=79.15 mmol. The amount of remaining NH₃ is 3.55+3.7−14.1×3.55%=6.75 mmol.

Using the Henderson-Hasselbalch equation, the solution pH after electrolysis reaction is

pH=pKₐ(NH₄⁺)+log₁₀([NH₃]/NH₄⁺])=9.25+log₁₀(6.75/79.15)=8.18

So, it may be assumed that the electrolyte pH is around 8.0 during the reaction. Note that the transport of OH⁻ through the AEM was not considered, because the concentration of HCO₃⁻ is much higher than OH⁻.

2. Obtaining the Standard Reduction Potential of CO₂/HCOO⁻ at pH=8.0

From CRC handbook, the following ΔG⁺ values can be found:

ΔG⁰ (HCOO⁻)=−351.0 KJ/mol, ΔG⁰ (OH⁻)=−157.2 KJ/mol, ΔG⁰ (CO₂, gas)=−394.4 KJ/mol, and ΔG⁰ (H₂O)=−237.1 KJ/mol.

The cathodic reaction is

CO₂+2e⁻H₂O→HCOO⁻+OH⁻

For this reaction, ΔG⁰=351.0−157.2−(−394.4)−(−237.1)=123.3 KJ/mol φ^{rev}(CO₂/HCOO⁻)=φ⁰ (CO₂/HCOO⁻)=−123.3×1000/(96485×2)=0.639 V_{SHE}

This corresponds to the standard condition at pH=14 ([OH⁻]=1 M). So, the reversible reduction potential at pH=8.0 is

φ^{rev}(CO₂/HCOO⁻, pH=8.0)=−0.639+0.0592/(2×log(1/[OH⁻]))=−0.639+0.05916/(2×log[1/(10⁻¹⁴/10^{-8.0})])=0.462 V_{SHE}

3. Obtaining Thermodynamic Cell Voltage for the pH-Asymmetric Configuration. For Clarity, φrev and Erev are Used to Stand for the “Reversible Electrode Potential” and the “Reversible Cell Voltage”, Respectively, Throughout this Document.

For the cell with AEM, the cathodic reaction is

CO₂+2e⁻+H₂O→HCOO⁻+OH⁻ (RXN 1, pH=8.0)

The reversible reduction potential for RXN 1 is −0.462 V_{SHE} as was calculated. And the anodic reaction is

4OH⁻→O₂+2H₂O+4e⁻ (RXN 2, pH =14)

The standard reduction potential for RXN 2 is 0.401 V_{SHE} from CRC handbook.

To calculate the thermodynamic cell voltage for the overall reaction, RXN 1 is multiplied by 2 and RXN 2 is added to eliminate the electrons:

2CO₂+4OH (pH 14)→2HCOO⁻+O₂+2OH⁻ (pH 8.0) (RXN 3)

Note that OH⁻ cannot be simply eliminated because of the difference in pH. The thermodynamic cell potential for RXN 3, E^{rev}(RXN 3), is −0.462−0.401=−0.863 V. In the actual cell configuration, because AEM can transport OH⁻, the following equation should apply:

2OH⁻(pH 8.0)→2OH⁻(pH 14) (RXN 4)

To calculate the reversible potential for this equation, the standard reduction potential of H₂O/H₂ may be used:

2H₂O+2e⁻→H₂+2OH⁻ (pH 14) (RXN 5)

φ^{rev}(H₂O/H₂, pH 14)=−0.828 V_{SHE} (from CRC handbook)

2H₂O+2e⁻→H₂+2OH (pH 8.0) (RXN 6)

φ^{rev}(H₂O/H₂, pH 8.0)=−0.828 V_{SHE}+0.05916/(2×log₁₀(1/[OH⁻]²))=−0.473 V_{SHE}.

RXN 4 corresponds to a cell constructed by using RXN 5 as the cathode, and RXN 6 as the anode.

Therefore, E^{rev} for RXN 4 is −0.828−(−0.473)=−0.355 V

By adding RXN 3 and RXN 4 the equation is:

2CO₂+2OH (pH 14)→2HCOO⁻+O₂ (RXN 7)

ΔG(RXN 7)=ΔG(RXN 3)+ΔG(RXN 4).

Because ΔG=−z·F·φ^{rev} for reduction electrode reaction or −z·F·E^{rev} for cell reaction, the equation is:

−4×F×E^{rev}(RXN 7)=−4×F×φ^{rev} (RXN 3)−2×F×E^{rev} (RXN 4)

E^{rev}(RXN 7)=φ^{rev}(RXN 3)+½×E^{rev}(RXN 4)=−0.863+½×(−0.355)=−1.040 V.

So, the thermodynamic cell voltage for RXN 7, E^{rev}(RXN 7), is 1.040 V, which is the thermodynamic cell voltage for our AEM-based electrolyzer.

Note that this value is exactly equal to the cell voltage when we directly calculate the E^{rev} of RXN 7 at standard conditions (pH=14):

φ⁰ (CO₂/HCOO⁻)=−0.639 V_{SHE} (we calculated this value before)

φ⁰ (O₂/OH⁻)=0.401 V_{SHE} (from CRC handbook)

The thermodynamic cell potential E⁰=−0.639−0.401=−1.040 V, corresponding to 1.040 V of thermodynamic cell voltage.

For the CEM electrolyzer (K⁺ transport) with NH₃HCO₃ feed (case 2-iv) and BPM electrolyzer with CO₂ capture solutions feed (case 2-i, 2-ii, and 2-iii), the catholyte pH was assumed at 8.0 and anolyte pH was 14.

The thermodynamic cell potential is E^{rev}=−0.462−0.401=−0.863 V, corresponding to thermodynamic cell voltage of 0.863 V.

Considering the different FE of cathodic product (FE_{c}) in different cell configurations, the actual thermal energy to produce 1 mole of formate product can be calculated as follows:

$$Δ {G}_{minimum} = - z \cdot F \cdot ( \frac{{E}_{cell - formate}^{rev}}{{FE}_{c}} ) ,$$

where, z is number of electrons required per mole of formate product; ΔGₘᵢₙᵢₘᵤₘ is the required minimum electrical energy applied to the electrolytic cell per unit of formate product, E_{cell-formate}^{o} is the standard reversible cell voltage for formate production.

From the literature, in the feeding of pure CO₂ (cases 1-i and 1-ii), the FE_{c} toward target products can attain ˜90% (Kirner et al., “Exploring Electrochemical Flow-Cell Designs and Parameters for CO₂ Reduction to Formate under Industrially Relevant Condition,” J. Electrochem. Soc. 169(5): (2022); Lee et al., “Bismuth Nanosheets Derived by In Situ Morphology Transformation of Bismuth Oxides for Selective Electrochemical CO₂ Reduction to Formate,” ACS Appl. Mater. Interfaces. 14(12): 14210-14217 (2022); which are hereby incorporated by reference in their entirety). In the feeding of KHCO₃ into the BPM-based electrolyzer (case 2-i), as was observed from the experimental results and the literature (Li et al., “Conversion of Bicarbonate to Formate in an Electrochemical Flow Reactor.” ACS Energy Lett. 5(8):2624-2630 (2020), which is hereby incorporated by reference in its entirety), the FE_{c} is assumed as 55%. In the feeding of MEA-CO₂ in the BPM-based electrolyzer (2-ii), the FE_{c} is assumed as 20% at the current density of 100 mA cm⁻². Based on the experimental results, in the feeding of NH₄HCO₃ to AEM (2-v), BPM (2-iii), and CEM (2-iv), the FE_{c}s are assumed as 90%, 80%, and 70%, respectively.

TABLE 5
Summary of thermodynamic energy for all cases.

| | E_{cell-formate}^{o} | FE_{c} | ΔGₘᵢₙᵢₘᵤₘ |
|---|---|---|---|
| Case | (V) | (%) | (kJ mol⁻¹) |
| 1-i | −1.040 | 90 | 223.0 |
| 1-ii | −1.040 | 90 | 223.0 |
| 2-i | −0.863 | 55 | 302.8 |
| 2-ii | −0.863 | 20 | 832.7 |
| 2-iii | −0.863 | 80 | 208.2 |
| 2-iv | −0.863 | 70 | 237.9 |
| 2-v | −1.040 | 90 | 223.0 |

### Cathode Energy Loss

Cathode energy loss is due to the overpotential for CO₂ reduction toward target products. Based on the literature, the overpotential of CO₂-to-formate on Bi-based catalysts was assumed at 100 mA cm⁻² is 0.7 V (Lee et al., “Bismuth Nanosheets Derived by In Situ Morphology Transformation of Bismuth Oxides for Selective Electrochemical CO₂ Reduction to Formate,” ACS Appl. Mater. Interfaces. 14(12): 14210-14217 (2022), which is hereby incorporated by reference in its entirety).

Then, the cathodic energy loss can be calculated, as follows:

Cathode energy loss=z·F·η/FE_{c},

where z is the number of electrons involved in the CO₂-to-formate reaction, and F is the Faraday constant (96,485 C·mol⁻¹).

### Anode Energy Loss

In the alkaline medium (e.g., 1 M KOH), the overpotential for OER on Ni-based catalysts can be as low as <400 mV at current density of 100 mA cm⁻². For example, the literature reported a nanostructured NiCo alloy that showed an overpotential of 326 mV (Wu et al., “A Nanostructured Nickel-cobalt Alloy With an Oxide Layer for an Efficient Oxygen Evolution Reaction,” J. Mater. Chem. 5(21): 10669-10677 (2017), which is hereby incorporated by reference in its entirety). So, this value was used to calculate anode energy loss, as follows:

Anode energy loss=z·F·η/FE_{c}=2×96485×0.326/FE_{c}

where z is the number of electrons involved in the CO₂-to-formate reaction, and F is the Faraday constant (96,485 C·mol⁻¹).

### Ohmic Loss

The Ohmic loss is mainly caused by the membrane resistance.

The potential drop (Δϕ) across the membrane is calculated as follows:

$$Δ ϕ = \frac{i L}{κ}$$

where i is the current density and L is the thickness of the membrane.

Based on the literature, the κ value for AEM (A201 membrane) is around 20 mS cm⁻¹ in OH⁻ (Duan et al., “Water Uptake, Ionic Conductivity and Swelling Properties of Anion-exchange Membrane,” J. Power Sources 243:773-778 (2013), which is hereby incorporated by reference in its entirety). With its thickness of 28 μm and at the current density of 100 mA cm⁻². the calculated Δϕ is 14 mV.

The κ value for Nafion 115 membrane is 21 mS cm⁻¹ in K⁺, so the Δϕ is 60 mV.

The BPM is thicker than AEM and CEM, because it is sandwiched by a cation exchange layer (CEL) and an anion exchange layer (AEL). The Δϕ value for BPM (Fumasep FBM) is assumed to be 280 mV at 100 mA cm⁻², based on the specification document. In addition, 0.828 V potential is required under the standard condition to dissociate water into H⁺ and OH⁻ by using BPM, which should also be included in the ohmic loss.

Therefore, the energy loss due to membrane resistance is calculated as follows:

For AEM and CEM cases: Ohmic loss=z·F·Δϕ/FE_{c}

For BPM cases: Ohmic loss=z·F·(Δϕ+0.828 V)/FE_{c}

### Separation of Product

In the near neutral media, an electrodialysis (ED) process is used to convert formate to formic acid before the separation of formic acid (Li et al., “CO₂ Electroreduction From Carbonate Electrolyte,” ACS Energy Lett. 4(6): 1427-1431 (2019), which is hereby incorporated by reference in its entirety). Then, a pressure-swing distillation (PSD) method is used for the separation of formic acid from the mixed solutions (Mahida et al., “Process Analysis of Pressure-swing Distillation for the Separation of Formic Acid-water Mixture,” Chem. Pap. 75(2):599-609 (2021), which is hereby incorporated by reference in its entirety). The reported energy consumption to separate formic acid is about 265 KJ/mol (Gu et al., “Modulating Electric Field Distribution by Alkali Cations for CO₂ Electroreduction in Strongly Acidic Medium,” Nat. Catal. 5(4): 1-9 (2022); Mahida et al., “Process Analysis of Pressure-swing Distillation for the Separation of Formic Acid-water Mixture,” Chem. Pap. 75(2): 599-609 (2021); which are hereby incorporated by reference in their entirety). The energy consumption in the ED process is ignored in our modeling, because of the much lower energy consumption than the PSD process (Gu et al., “Modulating Electric Field Distribution by Alkali Cations for CO₂ Electroreduction in Strongly Acidic Medium,” Nat. Catal. 5(4): 1-9 (2022), which is hereby incorporated by reference in its entirety).

In summary, the total energy consumption can be obtained by summing all components identified above: thermodynamic energy consumption, cathode energy loss, anode energy loss, ohmic energy loss, and separation energy use.

Although preferred embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow.

What is claimed:

1. An electrochemical method for converting captured CO₂ into formate (HCOO⁻), said method comprising:
capturing waste CO₂ by co-absorption of the waste CO₂ with green ammonia (NH3) to form ammonium bicarbonate (NH4HCO₃) and converting the ammonium bicarbonate (NH₄HCO₃) into formate (HCOO⁻), wherein said converting is carried out in an integrated flow electrolyzer system.

2. The method according to claim 1, wherein said capturing is carried out according to the following formula:
CO₂+H₂O+NH₃→NH₄HCO₃.

3. The method according to claim 1 or claim 2, wherein the integrated flow electrolyzer system comprises an alkaline electrolyzer for producing NH₃ from NO₃⁻.

4. The method according to claim 3, wherein the alkaline electrolyzer comprises an anode, a cathode, and a reaction medium. 5 The method according to any one of the preceding claims, wherein the reaction medium comprises a concentrated NaOH—KOH solution.

6. The method according to claim 4 or claim 5, wherein the anode and the cathode comprise nickel wire mesh or nickel alloys.

7. The method according to any one of claims 4-6, wherein the alkaline electrolyzer has no membrane between the anode and the cathode.

8. The method according to any one of the preceding claims, wherein the integrated flow electrolyzer system comprises an NH₃—CO₂ absorbing unit wherein said capturing is carried out.

9. The method according to any one of the preceding claims, wherein the integrated flow electrolyzer comprises a bicarbonate electrolyzer for carrying out said converting.

10. The method according to claim 9, wherein the bicarbonate electrolyzer comprises an anode, a cathode, and an anion exchange membrane.

11. The method according to claim 10, wherein the bicarbonate electrolyzer further comprises:
a reaction medium comprising ammonium bicarbonate (NH₄HCO₃); and
a power supply operably connected to the anode and the cathode.

12. The method according to claim 9 or claim 10, wherein the anode comprises nickel.

13. The method according to any one of claims 9-11, wherein the anode comprises nickel foam.

14. The method according to any one of claims 9-13, wherein the cathode comprises electrodeposited-Bi (ED-Bi).

15. The method according to claim 14, wherein the cathode is formed on carbon paper.

16. The method according to any one of the preceding claims, wherein said converting is carried out at a temperature of between 35-80° C.

17. The method according to any one of the preceding claims, wherein said converting is carried out at a temperature of between 40-60° C.

18. An integrated flow electrolyzer system comprising:
an alkaline electrolyzer for producing NH₃ from NO₃;
an NH₃—CO₂ absorbing unit whereby waste CO₂ is co-absorbed with ammonia (NH₃) to form ammonium bicarbonate (NH₄HCO₃); and
a bicarbonate electrolyzer for converting the ammonium bicarbonate (NH₄HCO₃) into formate (HCOO⁻).

19. The electrolyzer system according to claim 18, wherein the alkaline electrolyzer comprises a first anode, a first cathode, a first reaction medium, and a first power supply operably connected to the first anode and the first cathode.

20. The electrolyzer system according to claim 19, wherein the first reaction medium comprises a concentrated NaOH—KOH solution.

21. The electrolyzer system according to claim 19 or claim 20, wherein the first anode and the first cathode comprise nickel wire mesh.

22. The electrolyzer system according to any one of claims 18-21, wherein the alkaline electrolyzer has no membrane between the first anode and the first cathode.

23. The electrolyzer system according to any one of claims 18-22, wherein the bicarbonate electrolyzer comprises a second anode, a second cathode, and an anion exchange membrane.

24. The electrolyzer system according to claim 10, wherein the bicarbonate electrolyzer further comprises:
a second reaction medium comprising ammonium bicarbonate (NH₄HCO₃); and
a second power supply operably connected to the second anode and the second cathode.

25. The electrolyzer system according to claim 23 or claim 24, wherein the second anode comprises nickel.

26. The electrolyzer system according to any one of claims 23-25, wherein the second anode comprises nickel foam.

27. The electrolyzer system according to any one of claims 23-26, wherein the second cathode comprises electrodeposited-Bi (ED-Bi).

28. The electrolyzer system according to any one of claims 23-27, wherein the second cathode is formed on carbon paper.
